(19) United States
(12) Patent Application Publication
(10) Pub. No.: US 2026/0292177 A1
(43) Pub. Date: Sep. 24, 2026

(54) RECOGNITION-ENHANCED IMAGE COMPRESSION: METHODS AND SYSTEMS FOR OPTIMIZED MEDIA COMPRESSION UTILIZING RECOGNITION PHYSICS PRINCIPLES

(71) Applicant: Jonathan Washburn, Austin, TX (US)

(72) Inventor: Jonathan Washburn, Austin, TX (US)

(21) Appl. No.: 19/571,222

(22) Filed: Mar. 18, 2026

Related U.S. Application Data
(60) Provisional application No. 63/774,209, filed on Mar. 19, 2025.

(51) Int. Cl. H04N 19/13; H04N 19/124; H04N 19/18; H04N 19/30; H04N 19/91

(52) U.S. Cl. CPC H04N 19/13; H04N 19/124; H04N 19/18; H04N 19/30; H04N 19/91

(57) ABSTRACT

Systems, methods, apparatuses, and non-transitory computer-readable media are disclosed for recognition-enhanced media compression. Input digital media data are partitioned and transformed to generate transform coefficients. Nonnegative coefficient recognition metrics are determined for at least a subset of the transform coefficients, and a bounded recognition coverage function is applied to generate recognition response values. Recognition-scaled transform coefficients are generated using the recognition response values. Quantization values are determined based on a baseline quantization structure and a frequency-related metric associated with coefficient position, and the recognition-scaled transform coefficients are quantized using the quantization values. Quantized coefficients are entropy coded to generate compressed media data. In some embodiments, nonnegative region recognition metrics are determined for spatial regions of the input digital media data to generate region-priority outputs used to modify compression behavior. In some embodiments, compressed media data are decoded using inverse quantization, inverse recognition-aware coefficient reconstruction, and inverse transform processing.

### CROSS-REFERENCE TO RELATED APPLICATIONS

This application claims the benefit of and priority to U.S. Provisional Patent Application No. 63/774,209, filed Mar. 19, 2025, titled “Recognition-Enhanced Image Compression: Methods and Systems for Optimized Media Compression Utilizing Recognition Physics Principles.”

### BACKGROUND

The present disclosure relates generally to digital media processing, and more particularly to systems and methods for image compression, media compression, transform-domain signal processing, adaptive quantization, and recognition-informed compression control for digital images, image sequences, video data, and related media representations.

Digital image and media compression systems are widely used to reduce storage requirements, transmission bandwidth, memory utilization, and processing burdens associated with handling visual content. Conventional compression techniques commonly rely on transform-domain representations, predictive coding, quantization, entropy coding, and various rate-control strategies to reduce redundancy within image or video data while attempting to preserve visually important information.

Many existing compression frameworks apply transforms, such as discrete cosine transforms, wavelet transforms, integer transforms, or related frequency-domain decompositions, to represent image content in a form that can be more efficiently quantized and encoded. In many such systems, transformed coefficients are quantized according to fixed or semi-static quantization tables, matrices, or other quantization policies intended to approximate perceptual relevance across broad classes of content.

Although conventional compression approaches have achieved substantial adoption and success, such approaches often apply coefficient handling and quantization policies that are only partially adaptive to the actual informational significance of particular transform coefficients, spatial regions, textures, edges, structures, or semantically relevant image content present within a given media sample. As a result, conventional systems may allocate bits inefficiently across low-significance and high-significance content, particularly at elevated compression ratios or under constrained bitrate conditions.

In many practical implementations, lower-magnitude transform coefficients are attenuated or discarded primarily through thresholding and quantization decisions that do not fully account for a unified recognition-based measure of coefficient significance. Similarly, higher-frequency coefficients may be quantized aggressively according to generalized assumptions about perceptual irrelevance, even though certain higher-frequency structures may correspond to edges, boundaries, text, anatomical structures, remote-sensing features, or other content that remains important in the reconstructed media.

Conventional region-based compression systems likewise may use saliency maps, segmentation masks, or region-of-interest heuristics to assign different quality levels to different portions of an image. However, such approaches are often implemented as separate or loosely coupled mechanisms that do not operate according to a common bounded recognition function spanning coefficient scaling, quantization optimization, and spatial quality allocation. This separation can limit consistency and reduce the effectiveness of bitrate allocation across the overall compression pipeline.

Existing compression architectures may also exhibit reduced robustness when applied across different media classes, including natural images, synthetic images, text-bearing images, medical imagery, satellite imagery, hyperspectral imagery, surveillance imagery, mobile-device imagery, and video or frame-sequence content. A compression policy that performs acceptably for one class of content may underperform for another class of content because informationally significant structures can vary substantially across use cases.

In addition, many conventional systems rely on fixed codec assumptions regarding block size, transform selection, quantization progression, or frequency weighting behavior. Such fixed assumptions may not optimally reflect the actual recognition relevance of specific coefficients, regions, or patterns within the source media. Where content-adaptive mechanisms do exist, they may be narrowly defined, computationally fragmented, or insufficiently integrated into a unified mathematical framework suitable for broad implementation across software, hardware, distributed, and embedded systems.

Further, certain conventional techniques prioritize average perceptual quality metrics without providing a sufficiently flexible mechanism for preserving content that may be disproportionately important for downstream human or machine interpretation. For example, fine structural boundaries, text contours, medical features, geospatial features, or diagnostically relevant regions may warrant different treatment than background textures, low-importance smooth regions, or recognition-insignificant detail. Conventional systems do not always provide an integrated framework for distinguishing such content in a manner that can directly inform transform-domain scaling, quantization adjustment, and spatial bitrate allocation.

In view of the foregoing, there exists a need for improved compression systems and methods capable of using a recognition-informed framework to identify, weight, preserve, suppress, prioritize, and encode media content according to its relative informational and structural significance. There is a further need for such systems and methods to operate across multiple compression stages, including coefficient-domain processing, quantization control, region-based quality allocation, entropy-coding preparation, reconstruction control, and related encoding and decoding operations.

There is also a need for compression architectures that can be implemented in a manner compatible with a variety of transform types, quantization schemes, media formats, and deployment environments, including local devices, cloud systems, distributed processing systems, hardware accelerators, real-time media pipelines, archival workflows, and domain-specific imaging systems. There is a further need for such architectures to support lossy, near-lossless, and, in some embodiments, lossless or selectively lossless compression modes.

The present disclosure addresses these and other technical problems by providing recognition-enhanced image compression systems and methods in which one or more recognition-based functions are used to govern transform coefficient treatment, quantization behavior, segmentation-informed quality allocation, and related compression operations in a coordinated and technically integrated manner.

### SUMMARY

The present disclosure provides systems, methods, apparatuses, devices, and non-transitory computer-readable media for performing recognition-enhanced media compression using recognition-informed processing applied to image data, video data, image sequences, frame-based media, transform-domain representations, spatial-domain representations, and related encoded or decodable media structures. In various embodiments, a compression pipeline is configured to apply one or more recognition-based functions to media content in order to control coefficient scaling, quantization behavior, spatial prioritization, bitrate allocation, region-based compression quality, reconstruction behavior, and related encoding or decoding operations.

In some embodiments, a media compression method includes receiving input media data, generating a transformed representation of at least a portion of the input media data, computing one or more recognition metrics associated with transformed coefficients, and applying a recognition coverage function to the one or more recognition metrics to produce recognition-scaled coefficient values. The recognition-scaled coefficient values may then be quantized, encoded, entropy coded, stored, transmitted, or otherwise processed to generate a compressed media representation.

In some embodiments, a media compression method includes generating a quantization structure based on a baseline quantization structure and a recognition-informed adjustment function. The recognition-informed adjustment function may depend on a frequency metric, a coefficient-position metric, a band metric, a recognition significance metric, or combinations thereof. In certain embodiments, the resulting quantization structure provides differentiated quantization behavior across transform coefficients, bands, or regions so that informationally significant content is preserved more effectively while lower-significance content is more aggressively compressed.

In some embodiments, a media compression method includes generating a recognition-based segmentation map, quality map, priority map, or region-classification map for an image, video frame, block set, tile set, or other media subdivision. The segmentation map, quality map, priority map, or region-classification map may be used to assign different compression treatments to different media portions, including different transform selections, scaling policies, quantization levels, thresholds, entropy-coding treatments, reconstruction treatments, or bitrate allocations.

In some embodiments, the disclosure provides a recognition-scaled transform embodiment in which transform coefficients are modified according to a bounded recognition coverage function before quantization. In one implementation, a transformed coefficient value is scaled using a recognition coverage function applied to a nonnegative recognition metric derived from the coefficient. In one implementation, the recognition metric is based on an absolute value, normalized value, energy value, significance value, or related dimensionless coefficient metric. Such processing may suppress lower-significance coefficients while preserving or relatively favoring higher-significance coefficients in a controlled manner.

In some embodiments, the disclosure provides a recognition-optimized quantization embodiment in which a baseline quantization table, matrix, scalar, or coefficient-dependent quantization policy is modified according to a recognition-based function. In one implementation, coefficient positions associated with greater recognition relevance, greater frequency significance, or different structural importance are assigned modified quantization values that differ from a baseline quantization configuration. Such recognition-optimized quantization may be used alone or in combination with recognition-scaled coefficients, recognition-based segmentation, or both.

In some embodiments, the disclosure provides a recognition-based adaptive segmentation embodiment in which spatial-domain or spatiotemporal media regions are evaluated according to one or more recognition metrics, including edge metrics, contrast metrics, structural metrics, saliency metrics, motion metrics, text-related metrics, object-related metrics, anatomical metrics, geospatial metrics, or combinations thereof. A recognition coverage function may be applied to such metrics to generate a bounded priority measure that informs differential compression behavior across blocks, tiles, regions, frames, planes, channels, slices, or other media subdivisions.

In some embodiments, the recognition coverage function is defined in accordance with a bounded monotonic function that increases with increasing recognition metric magnitude while remaining controlled across the operating range. In one embodiment, the recognition coverage function is expressed as F_cov(r; X)=r /(r+X), where r is a nonnegative recognition metric and X is a positive parameter. In one embodiment, X is set to phi/pi. In other embodiments, X may be scaled, adapted, signaled, selected from a profile, learned, or otherwise determined according to implementation constraints, media class, bitrate target, content type, device capability, latency target, or quality target.

In some embodiments, the disclosure provides an encoder configured to receive media data, optionally preprocess the media data, partition the media data into blocks, tiles, or other subdivisions, generate transformed coefficients, apply recognition-based coefficient scaling, generate recognition-optimized quantization data, quantize the resulting coefficients, and entropy code symbols to produce a compressed bitstream. In some embodiments, the encoder further generates and signals parameter data, metadata, side information, profile information, segmentation information, transform identifiers, normalization information, and other data for use by a decoder, transcoder, storage system, or downstream processing system.

In some embodiments, the disclosure provides a decoder configured to parse a compressed bitstream, recover entropy-coded symbols, reconstruct quantized coefficient values, inverse quantize coefficient values, and perform inverse recognition-aware reconstruction. In some implementations, inverse recognition-aware reconstruction includes applying an exact inverse function, an approximate inverse function, a lookup-table-based inverse, an iterative inverse, or a compatible reconstruction function to recover a decoded coefficient representation prior to inverse transform and image reconstruction. In some embodiments, the decoder is recognition-aware. In some embodiments, the decoder operates in a compatibility mode.

In some embodiments, the disclosed subject matter may be implemented using discrete cosine transforms, discrete wavelet transforms, integer transforms, lapped transforms, hybrid transforms, multiscale transforms, temporal transforms, predictive residual transforms, or other transform-domain representations. In some embodiments, transform sizes and partitioning structures are fixed. In other embodiments, transform sizes and partitioning structures are adaptive, variable, hierarchical, region-dependent, frame-dependent, or content-dependent.

In some embodiments, the disclosed subject matter may be applied to still-image compression, video compression, frame-sequence compression, residual compression, cloud transcoding, mobile-device image capture, archival storage, surveillance systems, medical image compression, geospatial image compression, hyperspectral image compression, text-bearing image compression, and other machine-implemented visual data reduction workflows. In some embodiments, the disclosed techniques may be used in lossy compression modes. In some embodiments, the disclosed techniques may be used in near-lossless compression modes. In some embodiments, selected regions or classes of data may be compressed according to lossless or selectively lossless policies.

In some embodiments, the disclosed subject matter provides technical improvements over conventional systems by enabling coordinated recognition-informed processing across multiple compression stages rather than applying isolated or weakly coupled adaptivity mechanisms. In certain embodiments, this coordinated processing improves bitrate allocation, structural preservation, coefficient handling, reconstruction fidelity, or rate-distortion behavior for content in which informationally significant structures should be preferentially preserved relative to lower-significance structures.

In some embodiments, the disclosure provides subcombinations in which recognition-scaled coefficient processing is used without recognition-based segmentation, recognition-optimized quantization is used without recognition-scaled coefficient processing, recognition-based segmentation is used without recognition-optimized quantization, or any two of such mechanisms are used together. In further embodiments, all such mechanisms are used in a combined encoder-decoder architecture. Additional embodiments, implementations, variations, and advantages will be apparent from the following description, drawings, and claims.

### BRIEF DESCRIPTION OF THE DRAWINGS

The accompanying drawings, which are incorporated herein and form a part of the specification, illustrate exemplary embodiments of the present disclosure and, together with the description, serve to explain principles, features, and implementations of the disclosed subject matter.

FIG. 1 illustrates an example recognition-enhanced media compression system configured to receive input media, perform recognition-informed compression processing, generate compressed media output, and support corresponding decode-side reconstruction operations.

FIG. 2 illustrates an example encoder pipeline for recognition-enhanced media compression, including media intake, optional preprocessing, partitioning, transform generation, recognition-scaled coefficient processing, recognition-optimized quantization, entropy-coding preparation, and compressed bitstream generation.

FIG. 3 illustrates an example decoder pipeline for recognition-enhanced media decompression, including compressed bitstream intake, entropy decoding, inverse quantization, inverse recognition-aware coefficient reconstruction, inverse transform processing, and reconstructed media output generation.

FIG. 4 illustrates an example recognition coverage function behavior in which a bounded monotonic recognition function is applied to one or more recognition metrics for coefficient scaling, quantization control, segmentation control, or related compression operations.

FIG. 5 illustrates an example recognition-scaled transform coefficient processing flow in which transform coefficients are evaluated according to one or more recognition metrics and scaled according to a recognition coverage function prior to quantization.

FIG. 6 illustrates an example recognition-optimized quantization generation flow in which baseline quantization values are modified according to one or more recognition-informed metrics to produce adjusted quantization values for compression processing.

FIG. 7 illustrates an example recognition-based adaptive segmentation flow in which spatial-domain regions are evaluated using one or more recognition metrics to generate a quality map, priority map, segmentation map, or region-classification output for region-dependent compression control.

FIG. 8 illustrates an example combined compression workflow in which recognition-scaled coefficient processing, recognition-optimized quantization, and recognition-based adaptive segmentation are jointly applied within a unified media compression pipeline.

FIG. 9 illustrates an example transform-coefficient representation showing representative coefficient values before and after recognition-based scaling for a block or transform-domain media portion.

FIG. 10 illustrates an example quantization structure showing representative baseline quantization values and recognition-optimized quantization values for a transform-domain arrangement.

FIG. 11 illustrates an example region-based prioritization result showing differential compression treatment across media portions identified as higher-priority, intermediate-priority, and lower-priority regions.

### DETAILED DESCRIPTION

The present disclosure provides recognition-enhanced media compression systems and methods configured to improve compression performance by applying recognition-informed processing to media data during one or more stages of encoding, quantization, prioritization, storage, transmission, decoding, or reconstruction. In various embodiments, the disclosed subject matter operates on still images, image sequences, video frames, multichannel image data, grayscale data, color image data, multispectral image data, medical image data, geospatial image data, text-bearing image data, synthetic image data, or other machine-processable media representations.

In some embodiments, the disclosed techniques provide a technical improvement in media compression pipelines by controlling transform-domain coefficient treatment and quantization behavior using a bounded recognition coverage function, thereby improving bitrate allocation across coefficients, bands, and/or regions while maintaining structural features important for reconstruction, perception, and/or downstream machine interpretation. In some embodiments, these improvements are realized within encoder/decoder operations including coefficient scaling, quantization structure adjustment, and signaling of parameters used to reproduce reconstruction behavior at a decoder.

In various embodiments, the disclosed subject matter uses one or more recognition-based functions to govern how media content is treated within a compression pipeline. Such treatment may include coefficient-domain weighting, quantization-value adjustment, segmentation-informed compression control, bitrate allocation, threshold selection, reconstruction control, or combinations thereof. In some embodiments, the disclosed subject matter applies a bounded recognition coverage function to one or more recognition metrics derived from transform-domain data, spatial-domain data, region-based data, or combinations thereof so that compression behavior is adaptively influenced by the relative significance of media content.

In some embodiments, the disclosed subject matter is implemented as an encoder system configured to receive media input, optionally preprocess the media input, partition the media input into blocks, tiles, or other subdivisions, generate transformed coefficients, apply recognition-based coefficient scaling, generate recognition-optimized quantization data, quantize coefficient values, and entropy code corresponding symbols to produce a compressed media output. In some embodiments, the disclosed subject matter is implemented as a decoder system configured to parse compressed media data, entropy decode symbols, inverse quantize coefficient values, perform inverse recognition-aware coefficient reconstruction, apply inverse transform processing, and output reconstructed media data.

In various embodiments, the systems, methods, and non-transitory computer-readable media described herein correspond to one another, such that an encoder/decoder system may be configured to perform the method operations described herein, and such method operations may be implemented as processor-executable instructions stored on a non-transitory computer-readable medium and executed by one or more processors of a computing device, codec module, accelerator, or distributed processing system.

In some embodiments, the disclosed subject matter combines three principal recognition-enhanced compression mechanisms within a unified media compression framework. A first mechanism includes recognition-scaled transform coefficient processing, in which transform coefficients are modified using a recognition coverage function prior to quantization. A second mechanism includes recognition-optimized quantization, in which baseline quantization values are adjusted according to one or more recognition-informed metrics. A third mechanism includes recognition-based adaptive segmentation, in which spatial-domain or region-based media portions are prioritized for differential compression treatment according to one or more recognition metrics. In some embodiments, any one of these mechanisms may be used independently. In some embodiments, any two of these mechanisms may be used in combination. In some embodiments, all three mechanisms may be jointly used within the same media compression pipeline.

In one embodiment, the recognition coverage function is expressed as F_cov(r; X)=r/(r+X), where r is a nonnegative recognition metric and X is a positive parameter. In one embodiment, X is set equal to phi/pi. In other embodiments, X may be scaled, normalized, selected from a profile, dynamically updated, signaled in compressed media data, or otherwise determined according to implementation requirements, content type, rate targets, quality targets, hardware limitations, latency targets, or combinations thereof. Although this recognition coverage function is described in detail herein as one preferred embodiment, other bounded monotonic functions may be used in other embodiments provided that such functions produce controlled recognition-informed modulation of compression behavior.

As used herein, the term media data may refer to any image, frame, pixel array, plane, channel, tile, block set, image sequence, video sequence, volumetric slice set, multispectral data structure, or other digitally processable visual data arrangement. As used herein, the term recognition metric may refer to any nonnegative metric indicative of informational significance, structural significance, coefficient significance, regional significance, perceptual significance, machine-interpretive significance, or related content relevance. In some embodiments, a recognition metric is dimensionless. In some embodiments, a recognition metric is normalized prior to application of a recognition coverage function. In some embodiments, a recognition metric may be derived from coefficient magnitude, coefficient energy, local variance, gradient magnitude, contrast, saliency, motion, texture, object likelihood, text likelihood, anatomical relevance, geospatial relevance, or combinations thereof.

As used herein, the term transform coefficient may refer to a coefficient generated by a discrete cosine transform, discrete wavelet transform, integer transform, lapped transform, hybrid transform, multiscale transform, temporal transform, predictive residual transform, or another transform-domain representation. As used herein, the term baseline quantization structure may refer to a quantization table, matrix, scalar, rule set, profile value, band-specific quantization value, or other quantization reference used prior to recognition-informed modification. As used herein, the term segmentation map may refer to a quality map, priority map, region-classification map, mask, weighting arrangement, or other structure that differentiates compression treatment among spatial regions, tiles, blocks, frames, slices, or other media subdivisions.

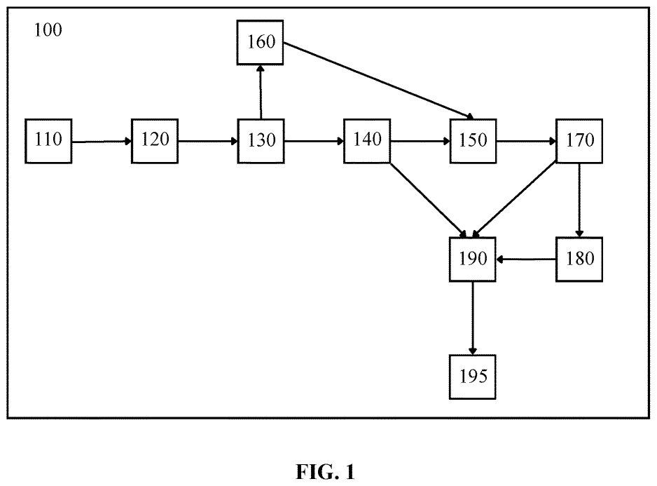

FIG. 1 illustrates an example recognition-enhanced media compression system 100 configured to receive input media, perform recognition-informed compression processing, generate compressed media output, and support corresponding decode-side reconstruction operations. In the illustrated embodiment, system 100 may include an input interface 110, a preprocessing engine 120, a transform processing engine 130, a recognition scaling engine 140, a quantization optimization engine 150, a segmentation and prioritization engine 160, an entropy coding and bitstream engine 170, a storage and transmission interface 180, a decoder and reconstruction engine 190, and an output interface 195. In various embodiments, one or more of the components shown in system 100 may be implemented in software, hardware, firmware, or combinations thereof, and one or more components may be combined, subdivided, reordered, omitted, or replicated.

Input interface 110 may be configured to receive source media data from any suitable origin. By way of example, input interface 110 may receive image files, compressed or uncompressed image data, raw sensor output, video frames, image sequences, medical imaging data, geospatial imagery, hyperspectral imagery, mobile-device image data, surveillance imagery, cloud-hosted media data, streamed media data, archived media data, or combinations thereof. In some embodiments, input interface 110 receives media data from a local memory, a camera subsystem, a scanner, a storage device, a network connection, a cloud resource, an edge device, a workstation, a mobile device, or a medical imaging system.

Preprocessing engine 120 may be configured to perform one or more optional preprocessing operations prior to transform-domain compression. Such preprocessing operations may include color-space conversion, bit-depth normalization, dynamic-range adjustment, gamma correction, denoising, demosaicing, deblocking preconditioning, resolution conversion, plane separation, channel reordering, metadata interpretation, cropping, padding, block alignment, tile alignment, contrast normalization, or combinations thereof. In some embodiments, preprocessing engine 120 converts RGB data to YCbCr data. In some embodiments, preprocessing engine 120 operates on grayscale data. In some embodiments, preprocessing engine 120 operates on multispectral or modality-specific image channels. In some embodiments, preprocessing engine 120 may be bypassed in whole or in part.

Transform processing engine 130 may be configured to partition media data into blocks, tiles, frames, regions, or other subdivisions and generate a transformed representation of at least part of the media data. In one embodiment, transform processing engine 130 applies a discrete cosine transform to block-based media data. In other embodiments, transform processing engine 130 applies a wavelet transform, integer transform, hybrid transform, multiscale transform, temporal transform, or other frequency-domain or transform-domain representation. In some embodiments, transform sizes may be fixed. In some embodiments, transform sizes may be variable, adaptive, hierarchical, region-dependent, frame-dependent, or content-dependent. In some embodiments, transform processing engine 130 operates separately on luma and chroma planes. In some embodiments, transform processing engine 130 operates on residual data in a predictive coding workflow.

Recognition scaling engine 140 may be configured to receive transformed coefficients from transform processing engine 130 and apply recognition-informed coefficient treatment to such coefficients. In one embodiment, recognition scaling engine 140 computes one or more recognition metrics associated with individual coefficients, groups of coefficients, coefficient bands, or transform regions and applies a recognition coverage function to such recognition metrics to generate recognition-scaled coefficient values. In one embodiment, a coefficient significance metric is based on an absolute value of a transform coefficient. In other embodiments, a coefficient significance metric may be based on normalized magnitude, normalized energy, local coefficient context, neighborhood coefficient patterns, band-specific statistics, noise estimates, or combinations thereof. In some embodiments, recognition scaling engine 140 preserves coefficient sign while modifying coefficient amplitude. In some embodiments, direct-current coefficients and alternating-current coefficients may be treated differently.

Quantization optimization engine 150 may be configured to generate recognition-optimized quantization values for use in compressing transformed media data. In one embodiment, quantization optimization engine 150 receives or generates a baseline quantization structure and adjusts such baseline quantization structure according to a recognition-informed function. In some embodiments, the recognition-informed function may depend on coefficient position, transform band, frequency metric, radial metric, zig-zag order, profile information, region classification, rate-control targets, or combinations thereof. In one embodiment, quantization optimization engine 150 generates recognition-optimized quantization values that are then applied to recognition-scaled coefficients produced by recognition scaling engine 140. In other embodiments, recognition-optimized quantization values may be applied without prior coefficient scaling. In some embodiments, quantization optimization engine 150 may generate integer quantization values, fixed-point quantization values, floating-point quantization values, clamped quantization values, or signaled quantization profiles.

Segmentation and prioritization engine 160 may be configured to evaluate media content in the spatial domain, transform domain, or a combined domain in order to generate a segmentation map, priority map, quality map, region-classification output, or other differential compression-control structure. In one embodiment, segmentation and prioritization engine 160 evaluates gradient magnitude and local contrast to generate a region significance measure. In other embodiments, segmentation and prioritization engine 160 may use edge metrics, variance metrics, saliency metrics, text-detection metrics, object-detection metrics, motion metrics, anatomical relevance metrics, geospatial feature metrics, texture metrics, or combinations thereof. In some embodiments, the output of segmentation and prioritization engine 160 is used to assign different compression policies to different spatial regions, including different quantization levels, different transform selections, different recognition-scaling strengths, different entropy-coding strategies, different threshold values, or different reconstruction priorities.

Entropy coding and bitstream engine 170 may be configured to quantize coefficient values using recognition-optimized quantization data, generate symbol sequences, reorder coefficient values, perform run-length processing, perform entropy coding, assemble compressed payload data, and generate compressed bitstream output. In some embodiments, entropy coding and bitstream engine 170 may use Huffman coding, arithmetic coding, context-adaptive coding, asymmetric numeral system coding, Golomb coding, run-length coding, or combinations thereof. In some embodiments, entropy coding and bitstream engine 170 also generates signaling data, parameter data, profile data, transform identifiers, block-size identifiers, segmentation identifiers, normalization indicators, recognition parameter indicators, or other side information that may be stored or transmitted with compressed media data for use during reconstruction or compatibility handling.

Storage and transmission interface 180 may be configured to store, buffer, write, stream, transmit, packetize, or otherwise output compressed media data. In some embodiments, storage and transmission interface 180 writes compressed media data to nonvolatile memory, removable media, a file system, or an archival system. In some embodiments, storage and transmission interface 180 transmits compressed media data over a wired or wireless network. In some embodiments, storage and transmission interface 180 provides compressed media data to a cloud service, content-delivery system, transcoding platform, mobile application, streaming endpoint, or remote workstation.

Decoder and reconstruction engine 190 may be configured to receive compressed media data from storage and transmission interface 180 or from another source and reconstruct corresponding media output. In one embodiment, decoder and reconstruction engine 190 parses compressed bitstream data, performs entropy decoding, recovers quantized coefficient values, applies inverse quantization, performs inverse recognition-aware coefficient reconstruction, applies inverse transform processing, and generates reconstructed media data. In some embodiments, inverse recognition-aware coefficient reconstruction may include application of an exact inverse function, an approximate inverse function, a lookup-table-based inverse, an iterative inverse, or a compatible reconstruction procedure. In some embodiments, decoder and reconstruction engine 190 may operate in a recognition-aware mode. In some embodiments, decoder and reconstruction engine 190 may operate in a compatibility mode in which certain recognition-related data are interpreted according to a legacy or reduced-complexity reconstruction policy.

Output interface 195 may be configured to provide reconstructed media data to a display, storage destination, downstream analytics system, editing workflow, transcoding workflow, machine-vision system, medical workstation, geospatial workstation, or other consumer of decoded media data. In some embodiments, output interface 195 delivers fully reconstructed media data. In some embodiments, output interface 195 delivers partially reconstructed media data, preview data, region-specific reconstructed data, or progressive reconstruction data.

In operation, system 100 may process media data according to a coordinated recognition-informed compression workflow. For example, input media received by input interface 110 may be preconditioned by preprocessing engine 120, transformed by transform processing engine 130, recognition-scaled by recognition scaling engine 140, quantized using recognition-optimized quantization values generated by quantization optimization engine 150, and region-prioritized according to outputs of segmentation and prioritization engine 160. The resulting data may then be entropy coded and assembled into compressed output by entropy coding and bitstream engine 170, stored or transmitted by storage and transmission interface 180, and subsequently reconstructed by decoder and reconstruction engine 190 for delivery through output interface 195. In some embodiments, one or more of these operations may occur in a different order, concurrently, iteratively, or selectively depending on implementation constraints.

Although FIG. 1 illustrates a particular arrangement of components, the disclosed subject matter is not limited to the illustrated architecture. In some embodiments, recognition scaling engine 140 and quantization optimization engine 150 may be implemented within a single compression-control engine. In some embodiments, segmentation and prioritization engine 160 may operate before transform processing engine 130, after transform processing engine 130, or both. In some embodiments, entropy coding and bitstream engine 170 may be integrated into a standardized codec framework or into a proprietary bitstream architecture. In some embodiments, decoder and reconstruction engine 190 may be implemented on the same device as the encoder-side components. In other embodiments, decoder and reconstruction engine 190 may be implemented on a separate client, server, cloud resource, playback device, mobile device, medical workstation, or networked endpoint.

In some embodiments, one or more components of system 100 may be accelerated using specialized hardware. For example, transform processing engine 130 may be implemented using a graphics processing unit, a vectorized processor, a field-programmable gate array, or an application-specific integrated circuit. Recognition scaling engine 140, quantization optimization engine 150, and segmentation and prioritization engine 160 may likewise be implemented using parallel hardware resources, fixed-point datapaths, lookup-table logic, or pipelined hardware structures. In some embodiments, all or part of system 100 may be implemented in software executed by one or more processors. In some embodiments, all or part of system 100 may be distributed across a client-server system, edge-cloud system, or other distributed computing environment.

In some embodiments, the disclosed system 100 may be used for lossy compression, near-lossless compression, selectively lossless compression, or mixed compression modes in which different media portions are compressed according to different fidelity requirements. By way of example, lower-priority background regions may be compressed more aggressively than higher-priority foreground regions, text regions, anatomical regions, geospatial feature regions, or other recognition-significant regions. In some embodiments, system 100 may be configured to preserve content that is significant for downstream machine interpretation, human inspection, diagnosis, navigation, archival fidelity, or combinations thereof.

The system-level architecture described with respect to FIG. 1 provides a non-limiting framework for understanding how recognition-enhanced coefficient processing, recognition-optimized quantization, and recognition-based adaptive segmentation may operate individually or together in a unified compression and reconstruction environment. Additional details regarding encoder flow, decoder flow, recognition coverage behavior, coefficient scaling, quantization optimization, segmentation generation, and combined processing workflows are described below with reference to subsequent figures.

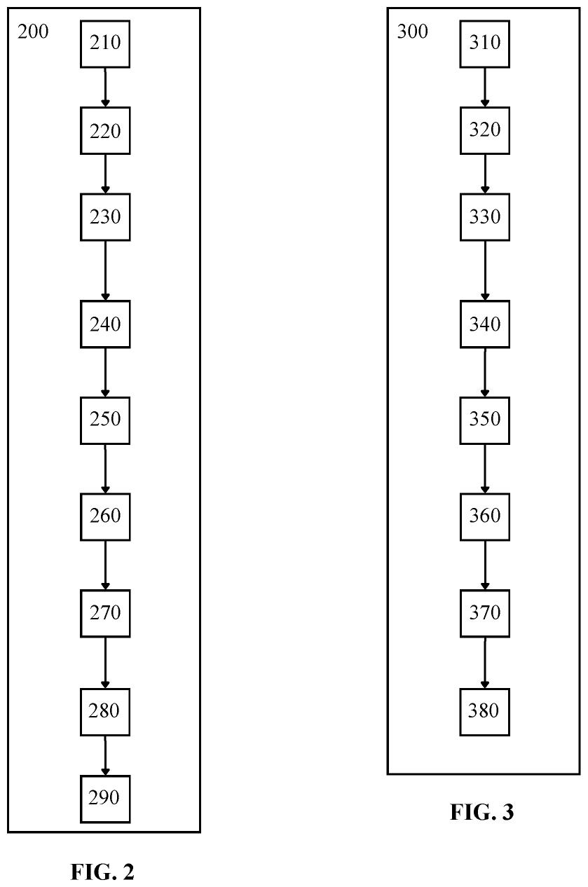

FIG. 2 illustrates an example encoder pipeline 200 for recognition-enhanced media compression. In the illustrated embodiment, encoder pipeline 200 may include a media intake stage 210, a preprocessing stage 220, a partitioning stage 230, a transform generation stage 240, a recognition-scaled coefficient stage 250, a recognition-optimized quantization stage 260, a symbol preparation stage 270, an entropy coding stage 280, and a compressed bitstream generation stage 290. In various embodiments, one or more stages of encoder pipeline 200 may be combined, subdivided, reordered, repeated, omitted, or implemented in parallel.

Media intake stage 210 may receive source media data for compression. In some embodiments, media intake stage 210 receives still-image data. In some embodiments, media intake stage 210 receives video frames, frame sequences, or residual data associated with predictive coding. In some embodiments, media intake stage 210 receives grayscale data, color image data, multispectral data, medical imaging data, geospatial data, text-bearing image data, synthetic image data, or other visual media data. In some embodiments, media intake stage 210 also receives associated metadata, such as color-space metadata, bit-depth metadata, profile metadata, device metadata, capture metadata, timing information, or application-specific information.

Preprocessing stage 220 may optionally condition the received media data prior to partitioning and transform generation. In some embodiments, preprocessing stage 220 performs one or more of color conversion, dynamic-range normalization, bit-depth conversion, denoising, demosaicing, alignment, cropping, padding, plane separation, chroma subsampling, normalization, contrast adjustment, or related preconditioning operations. In one embodiment, preprocessing stage 220 converts RGB image data into one or more luminance-chrominance representations. In another embodiment, preprocessing stage 220 preserves input media in its original channel representation. In some embodiments, preprocessing stage 220 may be partially or entirely bypassed.

Partitioning stage 230 may subdivide the media data into blocks, tiles, regions, slices, windows, planes, coding units, or other subdivisions suitable for compression processing. In one embodiment, partitioning stage 230 divides image data into block-based units for transform processing. In one embodiment, the blocks are 8 by 8 blocks. In other embodiments, partitioning stage 230 may use larger or smaller fixed-size blocks, rectangular blocks, variable-size blocks, hierarchical blocks, tiles, overlapping windows, multiscale partitions, region-adaptive partitions, or combinations thereof. In some embodiments, different partitions may be used for different channels, planes, image regions, or frame types.

Transform generation stage 240 may generate transformed representations for the partitioned media data. In one embodiment, transform generation stage 240 applies a discrete cosine transform to each block produced by partitioning stage 230. In other embodiments, transform generation stage 240 may apply a discrete wavelet transform, integer transform, lapped transform, predictive residual transform, hybrid transform, multiscale transform, temporal transform, or other transform-domain operation. In some embodiments, transform generation stage 240 produces coefficient arrays indexed according to horizontal and vertical frequency positions. In other embodiments, transform generation stage 240 produces subbands, hierarchical coefficient sets, multiresolution outputs, temporal-frequency outputs, or other transformed data structures.

Recognition-scaled coefficient stage 250 may receive transformed coefficients from transform generation stage 240 and generate recognition-scaled coefficients according to one or more recognition metrics. In one embodiment, recognition-scaled coefficient stage 250 computes a recognition metric for each coefficient based on the absolute value of the coefficient. In one embodiment, a transformed coefficient value d is processed according to a recognition coverage function F_cov(r; X)=r/(r +X), where r is a nonnegative recognition metric and X is a positive parameter. In one embodiment, a recognition-scaled coefficient C_RS is generated according to C_RS=d*F_cov(abs(d); X_eff), where X_eff is an effective recognition parameter. In one embodiment, X_eff is equal to phi/pi. In other embodiments, X_eff may be scaled, profiled, normalized, or adaptively selected.

In some embodiments, recognition-scaled coefficient stage 250 applies recognition scaling to all transform coefficients. In some embodiments, recognition-scaled coefficient stage 250 applies recognition scaling only to alternating-current coefficients. In some embodiments, direct-current coefficients are passed through unchanged, separately processed, or processed according to a different recognition policy. In some embodiments, recognition scaling may be applied differently by channel, by plane, by transform band, by frame type, by region, or by bitrate mode. In some embodiments, recognition-scaled coefficient stage 250 may include clamping, thresholding, coefficient-floor logic, coefficient-ceiling logic, sign preservation, fixed-point conversion, lookup-table approximation, or vectorized implementation logic.

Recognition-optimized quantization stage 260 may generate quantization values for use in quantizing the recognition-scaled coefficients. In one embodiment, recognition-optimized quantization stage 260 accesses or generates a baseline quantization structure Q_base. In one embodiment, recognition-optimized quantization stage 260 computes a frequency-related metric f_s for coefficient positions or transform bands. In one embodiment, recognition-optimized quantization values Q_RO are generated according to Q_RO=Q_base/(1+F_cov(f_s; X_eff)). In one embodiment, f_s may be based on coefficient coordinates. In other embodiments, f_s may be based on a radial metric, zig-zag order, band index, weighted position metric, temporal-frequency metric, or other nonnegative metric associated with transform-domain location or significance.

In some embodiments, recognition-optimized quantization stage 260 may further modify quantization values according to region-priority information, rate-control information, quality targets, device constraints, application constraints, or combinations thereof. In some embodiments, recognition-optimized quantization stage 260 may generate integer quantization values, fixed-point quantization values, floating-point quantization values, clamped quantization values, table-based quantization values, profile-based quantization values, or dynamically updated quantization structures. In some embodiments, quantization may be uniform for some coefficients and nonuniform for others. In some embodiments, a first quantization policy may be used for luma data and a second quantization policy may be used for chroma data.

In some embodiments, encoder pipeline 200 may also incorporate recognition-based segmentation information during or before recognition-optimized quantization stage 260. For example, region-priority outputs may be used to apply stronger compression to lower-priority regions and reduced compression to higher-priority regions. In some embodiments, segmentation information may modify transform selection, coefficient scaling strength, quantization strength, symbol ordering, bit allocation, threshold selection, entropy-coding context selection, or combinations thereof. In some embodiments, such segmentation information may be derived before transform generation stage 240, after transform generation stage 240, or through combined spatial-domain and transform-domain analysis.

Symbol preparation stage 270 may receive quantized coefficients and prepare such coefficients for entropy coding. In some embodiments, symbol preparation stage 270 performs coefficient scanning, coefficient ordering, zig-zag ordering, band ordering, run-length preparation, zero-run analysis, significance-map generation, context preparation, token generation, sign extraction, or other pre-entropy-coding operations. In one embodiment, symbol preparation stage 270 arranges quantized coefficients in an order that facilitates efficient compression of sparse high-frequency content. In some embodiments, symbol preparation stage 270 also prepares side information, including transform identifiers, block-size identifiers, profile identifiers, normalization indicators, segmentation indicators, recognition parameter indicators, quality-tier indicators, or combinations thereof.

Entropy coding stage 280 may receive prepared symbols from symbol preparation stage 270 and generate coded output symbols or coded bit sequences. In some embodiments, entropy coding stage 280 uses Huffman coding. In some embodiments, entropy coding stage 280 uses arithmetic coding. In some embodiments, entropy coding stage 280 uses context-adaptive coding, run-length coding, Golomb coding, ANS-based coding, or combinations thereof. In some embodiments, entropy coding stage 280 operates according to a legacy-compatible format. In some embodiments, entropy coding stage 280 operates according to a proprietary or hybrid format.

Compressed bitstream generation stage 290 may assemble entropy-coded data and associated signaling information into a compressed output representation. In some embodiments, compressed bitstream generation stage 290 generates a file, stream, packet sequence, frame payload, container payload, or memory object containing coded coefficient information and associated metadata. In some embodiments, the compressed output representation includes one or more of transform identifiers, quantization identifiers, recognition parameter identifiers, segmentation identifiers, compatibility flags, profile information, color-space information, bit-depth information, quality mode indicators, channel-mode indicators, lossless or near-lossless mode indicators, or other decoding-related information.

In one example operation, encoder pipeline 200 receives an image at media intake stage 210, optionally performs normalization and color-space handling at preprocessing stage 220, partitions the image into blocks at partitioning stage 230, computes transform coefficients at transform generation stage 240, recognition-scales such coefficients at recognition-scaled coefficient stage 250, generates recognition-optimized quantization values at recognition-optimized quantization stage 260, prepares resulting symbols at symbol preparation stage 270, entropy codes the symbols at entropy coding stage 280, and outputs a compressed bitstream at compressed bitstream generation stage 290. In some embodiments, one or more stages may be iteratively tuned in response to rate-control targets, perceptual targets, latency targets, or profile constraints.

In some embodiments, encoder pipeline 200 may operate in a lossy mode in which quantization and recognition-aware modulation produce reduced file size at some accepted reconstruction loss. In some embodiments, encoder pipeline 200 may operate in a near-lossless mode in which quantization strength is restricted or region-priority policies are configured to preserve high-significance regions with tighter bounds. In some embodiments, encoder pipeline 200 may operate in a mixed mode in which some regions, channels, or bands are compressed losslessly or near-losslessly while other regions, channels, or bands are compressed according to a more aggressive lossy policy.

In some embodiments, the encoder evaluates compression performance using at least one verification metric selected from (i) bitrate in bits per pixel (bpp), (ii) peak signal-to-noise ratio (PSNR), (iii) structural similarity (SSIM), (iv) a perceptual metric, or (v) a task metric for downstream recognition.

In one embodiment, an acceptance rule is applied such that the compressed media data are accepted when bpp≤B_target and SSIM≥S_min (or PSNR≥P_min), and otherwise one or more parameters including X_eff, a quantization scaling factor, or a region modifier T_seg are adjusted and encoding is repeated for the affected portions.

In one embodiment, X_eff is increased to suppress low-significance coefficients when bitrate exceeds B_target, and X_eff is decreased to preserve structure when SSIM/PSNR falls below the corresponding threshold.

In some embodiments, the verification metric and rule are applied per block, per tile, per frame, or per image, and the final bitstream signals a mode identifier indicating the selected metric and thresholds.

In some embodiments, encoder pipeline 200 may be implemented on one or more processors executing software instructions. In some embodiments, one or more stages of encoder pipeline 200 may be implemented using vectorized instruction sets, graphics processing units, field-programmable gate arrays, application-specific integrated circuits, digital signal processors, or other hardware accelerators. In some embodiments, distinct stages of encoder pipeline 200 may be distributed across different devices or computing nodes, such as a client device, an edge device, and a cloud-based compression service.

Although FIG. 2 illustrates a particular sequence of stages, the disclosed subject matter is not limited to the illustrated arrangement. For example, segmentation-driven priority handling may occur before partitioning stage 230, before transform generation stage 240, after transform generation stage 240, or in parallel with recognition-scaled coefficient stage 250. Similarly, recognition-optimized quantization stage 260 may operate using precomputed tables, dynamically generated values, signaled profiles, or machine-assisted policy selection. Additional details regarding decode-side reconstruction are described below with reference to FIG. 3.

FIG. 3 illustrates an example decoder pipeline 300 for recognition-enhanced media decompression. In the illustrated embodiment, decoder pipeline 300 may include a compressed bitstream intake stage 310, a bitstream parsing stage 320, an entropy decoding stage 330, an inverse quantization stage 340, an inverse recognition-aware coefficient reconstruction stage 350, an inverse transform stage 360, a post-processing stage 370, and a reconstructed media output stage 380. In various embodiments, one or more stages of decoder pipeline 300 may be combined, subdivided, reordered, repeated, omitted, or implemented in parallel.

Compressed bitstream intake stage 310 may receive compressed media data from a file, memory location, removable storage medium, network stream, packetized transmission, cloud service, server, mobile device, imaging workstation, or other source of encoded media data. In some embodiments, compressed bitstream intake stage 310 receives a standalone compressed file. In some embodiments, compressed bitstream intake stage 310 receives a payload embedded within a container format, transport stream, archival format, imaging format, or application-specific wrapper. In some embodiments, the received compressed media data includes coefficient payload data and one or more forms of associated signaling data.

Bitstream parsing stage 320 may parse the received compressed media data to identify payload segments, coding structures, coefficient representations, parameter indicators, transform identifiers, block-size identifiers, segmentation indicators, quality mode indicators, profile identifiers, color-space indicators, bit-depth indicators, compatibility flags, recognition-parameter indicators, or other information used in reconstruction. In some embodiments, bitstream parsing stage 320 validates headers, checks syntax, interprets mode fields, reconstructs side-information structures, and provides parsed information to downstream stages. In some embodiments, bitstream parsing stage 320 may support a proprietary recognition-enhanced format. In some embodiments, bitstream parsing stage 320 may support a compatibility arrangement in which recognition-enhanced data is conveyed alongside a legacy or semi-legacy coding structure.

Entropy decoding stage 330 may receive parsed bitstream content from bitstream parsing stage 320 and recover quantized symbol information for subsequent reconstruction. In some embodiments, entropy decoding stage 330 performs Huffman decoding. In some embodiments, entropy decoding stage 330 performs arithmetic decoding. In some embodiments, entropy decoding stage 330 performs context-adaptive decoding, run-length decoding, Golomb decoding, ANS-based decoding, or combinations thereof. In some embodiments, entropy decoding stage 330 reconstructs coefficient tokens, coefficient significance information, run-length information, coefficient ordering information, sign information, context information, or related symbol representations corresponding to encoded coefficient data.

Inverse quantization stage 340 may reconstruct dequantized coefficient values from the decoded coefficient information generated by entropy decoding stage 330. In one embodiment, inverse quantization stage 340 applies one or more quantization values corresponding to quantization parameters used during encoding. In some embodiments, inverse quantization stage 340 reconstructs coefficient magnitudes based on signaled recognition-optimized quantization values. In some embodiments, inverse quantization stage 340 derives quantization values from profile data, mode data, transform-position information, segmentation information, or combinations thereof. In some embodiments, inverse quantization stage 340 uses table-based, scalar-based, fixed-point, floating-point, or hybrid inverse quantization logic.

Inverse recognition-aware coefficient reconstruction stage 350 may reconstruct coefficient values corresponding to a pre-scaled or otherwise recognition-adjusted coefficient state. In one embodiment, inverse recognition-aware coefficient reconstruction stage 350 receives dequantized recognition-scaled coefficients and applies an inverse recognition-aware mapping. In one embodiment, where an encoded coefficient value C_RS corresponds to a transform coefficient value d modified according to C_RS=d*F_cov(abs(d); X_eff), inverse recognition-aware coefficient reconstruction stage 350 may recover d according to a closed-form inverse relation based on the same recognition coverage function. In one embodiment, where F_cov(r; X)=r/(r+X), the absolute value of d may be determined according to abs(d)=(abs(C_RS)+sqrt((abs(C_RS) * abs(C_RS))+(4*X_eff*abs(C_RS))))/2, and the recovered coefficient may be determined according to d=sign(C_RS)*abs(d).

In some embodiments, inverse recognition-aware coefficient reconstruction stage 350 may use an exact inverse relation. In some embodiments, inverse recognition-aware coefficient reconstruction stage 350 may use an approximate inverse relation. In some embodiments, inverse recognition-aware coefficient reconstruction stage 350 may use a lookup table, interpolation structure, iterative numerical procedure, polynomial approximation, reciprocal approximation, hardware approximation, or related reconstruction technique. In some embodiments, inverse recognition-aware coefficient reconstruction stage 350 may reconstruct only a subset of coefficients using inverse recognition-aware logic, while other coefficients are passed through or reconstructed according to a different policy. In some embodiments, direct-current coefficients and alternating-current coefficients may be reconstructed differently.

In some embodiments, inverse recognition-aware coefficient reconstruction stage 350 may operate in a recognition-aware decode mode in which recognition parameters are explicitly interpreted and used to reconstruct coefficient values according to the corresponding recognition-based encoding behavior. In some embodiments, inverse recognition-aware coefficient reconstruction stage 350 may operate in a compatibility mode in which scaled coefficients are treated as directly reconstructable coefficients without full inverse recognition-aware processing, or in which a simplified approximation is used. In some embodiments, such compatibility handling may trade some reconstruction fidelity for lower decoder complexity, reduced latency, or improved interoperability.

Inverse transform stage 360 may receive reconstructed coefficient values from inverse recognition-aware coefficient reconstruction stage 350 and generate reconstructed spatial-domain media data. In one embodiment, inverse transform stage 360 applies an inverse discrete cosine transform to block-based coefficients. In other embodiments, inverse transform stage 360 applies an inverse wavelet transform, inverse integer transform, inverse lapped transform, inverse multiscale transform, inverse temporal transform, or other inverse transform operation corresponding to the transform-domain representation used during encoding. In some embodiments, inverse transform stage 360 operates on luma and chroma data separately. In some embodiments, inverse transform stage 360 operates on residual data within a predictive reconstruction workflow.

Post-processing stage 370 may optionally perform one or more post-reconstruction operations on media data generated by inverse transform stage 360. In some embodiments, post-processing stage 370 performs color-space restoration, plane recombination, clipping, range normalization, deblocking, deringing, smoothing, edge refinement, artifact suppression, upsampling, channel restoration, noise handling, or combinations thereof. In some embodiments, post-processing stage 370 may be omitted. In some embodiments, post-processing stage 370 may be selectively applied based on mode settings, device capabilities, content type, or application requirements.

Reconstructed media output stage 380 may output reconstructed media data for display, storage, analytics, machine interpretation, medical review, geospatial analysis, editing, transcoding, retransmission, or other downstream use. In some embodiments, reconstructed media output stage 380 outputs a reconstructed still image. In some embodiments, reconstructed media output stage 380 outputs a reconstructed frame, frame sequence, or video stream. In some embodiments, reconstructed media output stage 380 outputs one or more selected regions, selected channels, preview frames, progressive reconstruction layers, or application-specific derivative outputs.

In one example operation, decoder pipeline 300 receives compressed media data at compressed bitstream intake stage 310, parses the bitstream at bitstream parsing stage 320, entropy decodes symbols at entropy decoding stage 330, inverse quantizes coefficient values at inverse quantization stage 340, performs inverse recognition-aware coefficient reconstruction at inverse recognition-aware coefficient reconstruction stage 350, applies inverse transform processing at inverse transform stage 360, optionally post-processes the reconstructed output at post-processing stage 370, and delivers reconstructed media data at reconstructed media output stage 380. In some embodiments, one or more stages may operate iteratively, concurrently, or adaptively according to quality mode, latency constraints, compatibility requirements, hardware availability, or application context.

In some embodiments, decoder pipeline 300 may be implemented in software executed by one or more processors. In some embodiments, one or more stages of decoder pipeline 300 may be implemented using graphics processing units, vector-processing hardware, digital signal processors, field-programmable gate arrays, application-specific integrated circuits, or related hardware accelerators. In some embodiments, decoder pipeline 300 may execute on a playback device, mobile device, workstation, cloud server, browser environment, embedded system, imaging workstation, or other computing platform. In some embodiments, different portions of decoder pipeline 300 may be distributed across different devices or services.

Although FIG. 3 illustrates a particular decode-side arrangement, the disclosed subject matter is not limited to the illustrated sequence or structure. For example, certain parsing operations may be integrated into entropy decoding stage 330. In some embodiments, inverse recognition-aware coefficient reconstruction stage 350 may be partially integrated with inverse quantization stage 340 or inverse transform stage 360. In some embodiments, post-processing stage 370 may incorporate application-specific enhancements for medical, geospatial, archival, mobile, or streaming use cases. Further details regarding the recognition coverage function used throughout the disclosed compression framework are described below with reference to FIG. 4.

FIG. 4 illustrates an example recognition coverage function behavior 400 in which a bounded monotonic recognition function is applied to one or more recognition metrics for coefficient scaling, quantization control, segmentation control, or related compression operations. In the illustrated embodiment, recognition coverage function behavior 400 may include a recognition metric input 410, a recognition coverage function definition 420, a parameter selection component 430, a recognition response output 440, and a compression-control application layer 450. In various embodiments, one or more portions of recognition coverage function behavior 400 may be implemented mathematically, algorithmically, through table lookup, through approximation logic, through fixed-point or floating-point computation, or through combinations thereof.

In one embodiment, the recognition coverage function is expressed as F_cov(r; X)=r/(r+X), where r is a nonnegative recognition metric and X is a positive parameter. In this embodiment, the function increases as r increases, remains bounded, and provides a controlled modulation of compression behavior across a range of recognition metric values. In one embodiment, X is set equal to phi/pi. In other embodiments, X may be assigned another positive value, may be scaled from phi/pi, may be selected from a predefined profile, may be adaptively selected based on media content, or may be signaled as part of encoded media data.

Recognition metric input 410 may correspond to any nonnegative metric indicative of content significance, coefficient significance, regional significance, structural relevance, perceptual relevance, machine-interpretive relevance, or related recognition-informed importance. In some embodiments, recognition metric input 410 is dimensionless. In some embodiments, recognition metric input 410 is normalized before being processed by recognition coverage function definition 420. In some embodiments, recognition metric input 410 may be derived from coefficient magnitude, normalized coefficient magnitude, coefficient energy, normalized coefficient energy, local variance, contrast, gradient magnitude, saliency, motion, texture, text-related features, object-related features, anatomical features, geospatial features, or combinations thereof.

In one embodiment, recognition metric input 410 is denoted as r and is constrained to satisfy r is greater than or equal to zero. In some embodiments, negative source values may be converted to nonnegative recognition metrics by applying an absolute-value operation, a magnitude operation, a squaring operation, an energy operation, a norm operation, a clipping operation, or another nonnegative mapping. In some embodiments, recognition metric input 410 may be scaled so that differing content classes, bit depths, coefficient ranges, transform types, or region metrics are evaluated under a common or comparable operational range.

Recognition coverage function definition 420 may generate a recognition response value based on the received recognition metric input 410 and parameter selection component 430. In one embodiment, the recognition response value is bounded between zero and one for nonnegative r and positive X. In such an embodiment, when r is near zero, the recognition response value is also near zero. As r increases relative to X, the recognition response value increases. As r becomes large relative to X, the recognition response value approaches one. In this manner, the recognition coverage function provides a gradual, bounded, and monotonic response that can be used to modulate compression behavior without requiring abrupt threshold transitions.

Parameter selection component 430 may determine the positive parameter X used by recognition coverage function definition 420. In one embodiment, X is a constant for an entire encoding session. In one embodiment, X is set equal to phi/pi. In other embodiments, X may be determined according to content type, bitrate target, quality target, device capabilities, power budget, latency constraints, channel type, transform type, segmentation class, frame type, region type, or combinations thereof. In some embodiments, an effective parameter X_eff is defined according to X_eff=gamma*X_opt, where X_opt is a baseline parameter and gamma is a scaling factor. In one embodiment, X_opt=phi/pi. In some embodiments, gamma may be fixed, selected from a profile, adaptively updated, or learned.

Recognition response output 440 may be used directly or indirectly to influence one or more compression-control operations in compression-control application layer 450. In some embodiments, recognition response output 440 is used to scale transformed coefficients. In some embodiments, recognition response output 440 is used to modify quantization values. In some embodiments, recognition response output 440 is used to generate segmentation priorities, quality tiers, region maps, or bitrate-allocation modifiers. In some embodiments, recognition response output 440 is used to influence threshold values, entropy-coding decisions, reconstruction behavior, or combinations thereof.

In one embodiment, recognition coverage function behavior 400 is used in recognition-scaled coefficient processing by applying the function to a coefficient-derived recognition metric. In one implementation, a transformed coefficient value d is processed according to C_RS=d*F_cov(abs(d); X_eff), where C_RS is a recognition-scaled coefficient, abs(d) is an absolute-value-based recognition metric, and X_eff is an effective recognition parameter. In such an embodiment, lower-magnitude coefficients may be relatively suppressed while higher-magnitude coefficients may be relatively preserved in a bounded and continuous manner. In some embodiments, the sign of d is preserved.

In one embodiment, recognition coverage function behavior 400 is used in recognition-optimized quantization by applying the function to a frequency-related metric, coefficient-position metric, band metric, or other transform-location-related metric. In one implementation, Q_RO=Q_base/(1+F_cov(f_s; X_eff)), where Q_base is a baseline quantization value, Q_RO is a recognition-optimized quantization value, and f_s is a nonnegative metric associated with coefficient position, transform-band significance, radial frequency, zig-zag order, or related transform-domain structure. In some embodiments, this arrangement produces differentiated quantization values across coefficient positions or transform bands.

In one embodiment, recognition coverage function behavior 400 is used in recognition-based adaptive segmentation by applying the function to a region-based recognition metric. In one implementation, a region metric r_seg may be computed from gradient magnitude, local contrast, structural strength, saliency, motion, or combinations thereof, and a corresponding recognition response R may be generated according to R=F_cov(r_seg; X_eff). In some embodiments, R is used to assign a quality level, bitrate priority, compression policy, transform policy, threshold policy, or reconstruction policy for an associated region.

In some embodiments, the function F_cov(r; X)=r/(r+X) is preferred because it provides a bounded and monotonic response while remaining computationally efficient to evaluate. In some embodiments, the function may be implemented using direct division. In some embodiments, the function may be implemented using reciprocal approximation, lookup tables, interpolation, polynomial approximation, fixed-point arithmetic, floating-point arithmetic, vectorized instructions, pipelined logic, or hardware acceleration. In some embodiments, the computational representation of the function may differ from its conceptual or analytical form while remaining operationally equivalent or substantially equivalent over an intended operating range.

Although the function F_cov(r; X)=r/(r+X) is described herein as a preferred embodiment, the disclosed subject matter is not limited to this exact function in all embodiments. In some embodiments, another bounded monotonic function may be used, provided that the function maps nonnegative recognition input to a controlled recognition response suitable for influencing compression behavior. In some embodiments, such alternative functions may be selected to improve implementation efficiency, numeric stability, hardware simplicity, codec compatibility, domain-specific tuning, or content-specific optimization. In some embodiments, the exact functional form may vary across different stages of the compression pipeline.

In some embodiments, recognition coverage function behavior 400 may be used with normalization logic so that different input metric types operate within a common or harmonized range. For example, coefficient-magnitude metrics, frequency-position metrics, segmentation metrics, and motion-related metrics may be individually normalized before application of the recognition coverage function. In some embodiments, normalization parameters may be fixed. In some embodiments, normalization parameters may be adaptively computed from content statistics. In some embodiments, normalization parameters may be signaled in encoded media data or selected according to a profile.

In some embodiments, the recognition coverage function may be evaluated separately for each coefficient, region, block, tile, frame, band, or channel. In some embodiments, the recognition coverage function may be evaluated once for a group of coefficients or a shared region class and then reused for multiple elements. In some embodiments, reuse of function outputs may reduce computational overhead while preserving recognition-informed adaptivity. In some embodiments, the granularity of recognition coverage function evaluation may be selected according to throughput requirements, memory limits, hardware architecture, content type, or latency requirements.

In some embodiments, parameter selection component 430 and recognition response output 440 may be jointly controlled as part of a rate-control or quality-control policy. For example, when a target bitrate is reduced, a system may modify X_eff, normalization scales, segmentation thresholds, or quantization policies while continuing to use the same recognition coverage function form. In some embodiments, such joint control may provide a coordinated framework for maintaining desired quality levels in higher-priority regions while increasing compression aggressiveness in lower-priority regions or lower-significance coefficients.

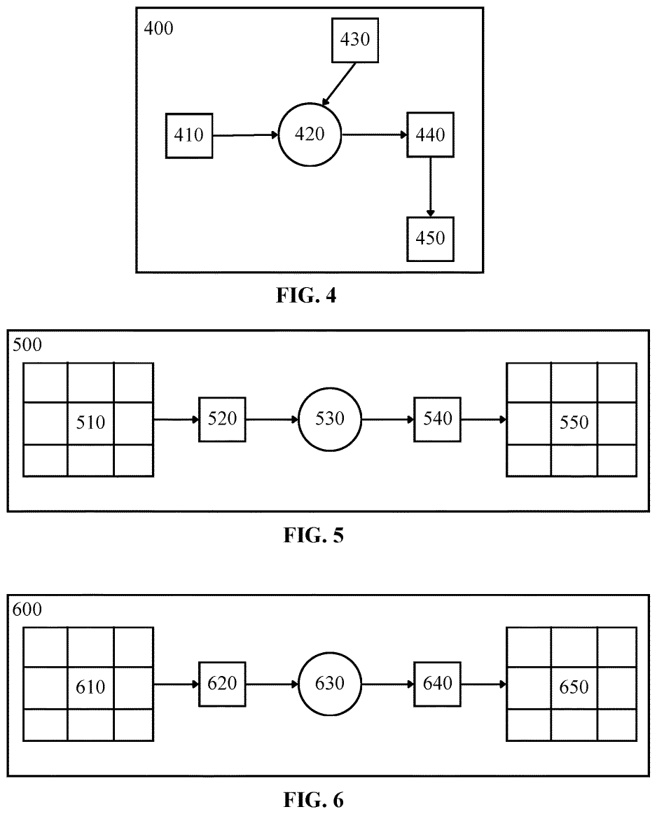

The recognition coverage function behavior illustrated in FIG. 4 provides a unifying mathematical framework for the coefficient-scaling, quantization-adjustment, and segmentation-prioritization mechanisms disclosed herein. Additional details regarding coefficient-level application of the recognition coverage function are described below with reference to FIG. 5.

FIG. 5 illustrates an example recognition-scaled transform coefficient processing flow 500 in which transform coefficients are evaluated according to one or more recognition metrics and scaled according to a recognition coverage function prior to quantization. In the illustrated embodiment, recognition-scaled transform coefficient processing flow 500 may include a transformed coefficient input stage 510, a coefficient recognition metric stage 520, a recognition coverage evaluation stage 530, a coefficient scaling stage 540, and a scaled coefficient output stage 550. In various embodiments, one or more stages of recognition-scaled transform coefficient processing flow 500 may be combined, subdivided, reordered, repeated, omitted, or implemented in parallel.

Transformed coefficient input stage 510 may receive one or more transform coefficients generated from input media data. In one embodiment, transformed coefficient input stage 510 receives coefficients generated by a discrete cosine transform applied to block-based image data. In other embodiments, transformed coefficient input stage 510 may receive coefficients generated by a discrete wavelet transform, integer transform, lapped transform, hybrid transform, multiscale transform, temporal transform, or other transform-domain representation. In some embodiments, transformed coefficient input stage 510 receives coefficient arrays corresponding to luma data, chroma data, grayscale data, multispectral data, residual data, or combinations thereof.

Coefficient recognition metric stage 520 may generate one or more nonnegative recognition metrics corresponding to the received transform coefficients. In one embodiment, the recognition metric for a coefficient is based on the absolute value of the coefficient. In one implementation, where a transform coefficient is represented as d, the recognition metric r_coeff may be defined as r_coeff=abs(d). In other embodiments, r_coeff may be based on normalized magnitude, normalized energy, squared magnitude, neighborhood-aware significance, local band energy, signal-to-noise estimate, context-dependent significance, or another nonnegative coefficient-related metric. In some embodiments, the recognition metric is dimensionless. In some embodiments, the recognition metric is normalized before further processing.

In some embodiments, coefficient recognition metric stage 520 may apply different recognition metric policies to different coefficient classes. For example, direct-current coefficients may be processed according to a first recognition policy and alternating-current coefficients may be processed according to a second recognition policy. In some embodiments, lower-frequency coefficients and higher-frequency coefficients may be evaluated according to different normalization policies. In some embodiments, a first recognition metric policy may be used for luma coefficients and a second recognition metric policy may be used for chroma coefficients. In some embodiments, recognition metric selection may vary according to region priority, transform type, frame type, profile selection, application mode, or combinations thereof.

Recognition coverage evaluation stage 530 may apply a recognition coverage function to the coefficient recognition metric generated by coefficient recognition metric stage 520. In one embodiment, recognition coverage evaluation stage 530 computes F_cov(r; X)=r/(r+X), where r is the nonnegative recognition metric and X is a positive parameter. In one embodiment, X is set equal to phi/pi. In some embodiments, an effective recognition parameter X_eff is used in place of X, and X_eff may be fixed, scaled, adaptively selected, signaled, profiled, or learned. In one embodiment, recognition coverage evaluation stage 530 computes a coefficient response value according to F_cov(abs(d); X_eff).

Coefficient scaling stage 540 may generate a recognition-scaled coefficient using the response generated by recognition coverage evaluation stage 530. In one embodiment, coefficient scaling stage 540 computes a recognition-scaled coefficient C_RS according to C_RS=d*F_cov(abs(d); X_eff). In such an embodiment, the sign of d is preserved while the magnitude of d is modulated according to the bounded recognition response. In some embodiments, when abs(d) is relatively small compared to X_eff, the resulting recognition-scaled coefficient magnitude is reduced to a greater extent. In some embodiments, when abs(d) is relatively large compared to X_eff, the resulting recognition-scaled coefficient magnitude is less attenuated. In this manner, coefficient scaling stage 540 may suppress lower-significance coefficients while relatively preserving higher-significance coefficients in a smooth and bounded fashion.

In some embodiments, coefficient scaling stage 540 may apply coefficient scaling to all coefficients within a block, tile, frame, subband, or other transformed media portion. In some embodiments, coefficient scaling stage 540 may apply coefficient scaling only to a subset of coefficients, such as alternating-current coefficients, coefficients above a selected band threshold, coefficients within selected subbands, coefficients associated with selected channels, or coefficients associated with selected regions. In some embodiments, coefficient scaling stage 540 may bypass scaling for coefficients that satisfy one or more criteria, such as coefficients identified as direct-current coefficients, coefficients corresponding to protected regions, or coefficients associated with a lossless or near-lossless mode.

In some embodiments, coefficient scaling stage 540 may incorporate one or more supplemental operations. For example, coefficient scaling stage 540 may apply clipping, minimum-floor logic, maximum-ceiling logic, coefficient thresholding, rounding, fixed-point conversion, sign extraction, coefficient grouping, or numerical stabilization. In some embodiments, coefficient scaling stage 540 may use direct arithmetic. In some embodiments, coefficient scaling stage 540 may use lookup tables, interpolation, reciprocal approximation, polynomial approximation, or vectorized instruction execution. In some embodiments, coefficient scaling stage 540 may be implemented using graphics processing hardware, a field-programmable gate array, a digital signal processor, an application-specific integrated circuit, or another hardware accelerator.

Scaled coefficient output stage 550 may output recognition-scaled coefficients for downstream compression processing. In one embodiment, scaled coefficient output stage 550 provides recognition-scaled coefficients to a recognition-optimized quantization stage. In some embodiments, scaled coefficient output stage 550 provides recognition-scaled coefficients to a thresholding stage, a symbol preparation stage, an entropy-coding preparation stage, a storage buffer, or a hybrid compression-control stage. In some embodiments, scaled coefficient output stage 550 may also output associated side information, coefficient class information, region-priority information, mode identifiers, or profile identifiers.

In one example operation, transformed coefficient input stage 510 receives a coefficient d from a transform-domain representation of an image block. Coefficient recognition metric stage 520 computes r_coeff=abs(d). Recognition coverage evaluation stage 530 computes a recognition response according to F_cov(abs(d); X_eff). Coefficient scaling stage 540 then computes C_RS=d*F_cov(abs(d); X_eff). The resulting C_RS value is provided by scaled coefficient output stage 550 for subsequent quantization and coding. In some embodiments, this operation is repeated for each coefficient in a coefficient set. In some embodiments, the operation is selectively applied to only part of a coefficient set.

In some embodiments, the recognition-scaled transform coefficient processing flow 500 may be applied in conjunction with neighborhood-aware or group-aware logic. For example, the recognition metric for a given coefficient may be influenced by adjacent coefficients, local energy distributions, subband statistics, directional patterns, or block-level structure. In some embodiments, such context-aware operation may improve handling of structured features, text-like regions, edge-rich regions, or repeated textures. In some embodiments, recognition-scaled coefficient processing may be performed independently of segmentation. In some embodiments, recognition-scaled coefficient processing may be modulated by outputs of a segmentation or region-priority system.

In some embodiments, the disclosed coefficient-scaling approach may be used with transform representations other than a standard block DCT. For example, when the transform-domain representation is wavelet-based, recognition-scaled transform coefficient processing flow 500 may be applied to coefficients within one or more wavelet subbands. When the transform-domain representation is temporal or residual-based, recognition-scaled transform coefficient processing flow 500 may be applied to residual coefficients, temporal coefficients, or predictive-error coefficients. When the transform-domain representation is multiscale or hierarchical, recognition-scaled transform coefficient processing flow 500 may be selectively applied at one or more scales or levels.

In some embodiments, recognition-scaled transform coefficient processing flow 500 may support different operating modes. In a first mode, the scaling function may be fixed for all input content. In a second mode, the effective recognition parameter may vary according to rate target or quality target. In a third mode, scaling may be stronger for lower-priority regions and weaker for higher-priority regions. In a fourth mode, the coefficient-scaling stage may be selectively disabled for selected regions, channels, or coefficient classes. In some embodiments, two or more such modes may be combined.

Although FIG. 5 illustrates a coefficient-level recognition-scaling workflow using a particular recognition coverage function and a particular absolute-value-based recognition metric, the disclosed subject matter is not limited to this exact arrangement in all embodiments. Other nonnegative coefficient significance metrics, normalization strategies, scaling implementations, and coefficient-selection policies may be used while preserving the general principle of recognition-informed coefficient modulation prior to quantization. Further details regarding recognition-optimized quantization are described below with reference to FIG. 6.

FIG. 6 illustrates an example recognition-optimized quantization generation flow 600 in which baseline quantization values are modified according to one or more recognition-informed metrics to produce adjusted quantization values for compression processing. In the illustrated embodiment, recognition-optimized quantization generation flow 600 may include a baseline quantization input stage 610, a quantization-metric determination stage 620, a recognition coverage evaluation stage 630, a quantization adjustment stage 640, and an optimized quantization output stage 650. In various embodiments, one or more stages of recognition-optimized quantization generation flow 600 may be combined, subdivided, reordered, repeated, omitted, or implemented in parallel.

Baseline quantization input stage 610 may receive or generate one or more baseline quantization values for use in transform-domain compression. In one embodiment, baseline quantization input stage 610 receives a baseline quantization matrix for block-based coefficient quantization. In other embodiments, baseline quantization input stage 610 may receive a quantization table, scalar quantization policy, band-specific quantization values, codec-profile quantization values, position-dependent quantization values, frame-type-dependent quantization values, channel-specific quantization values, or another baseline quantization structure. In some embodiments, the baseline quantization structure may be predetermined. In some embodiments, the baseline quantization structure may be adaptively generated. In some embodiments, the baseline quantization structure may be signaled, profile-selected, application-selected, or learned.

Quantization-metric determination stage 620 may determine one or more nonnegative metrics used to recognition-optimize baseline quantization values. In one embodiment, quantization-metric determination stage 620 determines a frequency-related metric associated with coefficient position. In one implementation, the metric may be based on horizontal and vertical coefficient coordinates. In one embodiment, the metric f_s for a coefficient position may be based on u+v. In other embodiments, the metric may be based on sqrt((u*u)+(v*v)), zig-zag position, radial position, band index, weighted position, temporal-frequency index, subband class, region-priority class, or another transform-location-related or significance-related measure. In some embodiments, the metric may be normalized before further processing. “In one implementation for an N×N block transform, for coefficient coordinates (u,v) with u,v∈{0 . . . N−1}, the frequency-related metric is f_s=u+v or f_s=sqrt(u\hat{ }2+v\hat{ }2), optionally normalized by (2N−2).”

In some embodiments, quantization-metric determination stage 620 may incorporate region-priority information, quality-tier information, frame-type information, bitrate targets, device constraints, power constraints, latency constraints, or combinations thereof. For example, a first metric policy may be used for luma coefficients and a second metric policy may be used for chroma coefficients. In some embodiments, a first metric policy may be used for higher-priority regions and a second metric policy may be used for lower-priority regions. In some embodiments, quantization-metric determination stage 620 may generate distinct metrics for different transform types, different block sizes, different content classes, or different operational profiles.

Recognition coverage evaluation stage 630 may apply a recognition coverage function to the quantization metric generated by quantization-metric determination stage 620. In one embodiment, recognition coverage evaluation stage 630 computes F_cov(r; X)=r/(r+X), where r corresponds to the selected quantization metric and X is a positive parameter. In one embodiment, X is set equal to phi/pi. In some embodiments, an effective recognition parameter X_eff is used. In some embodiments, X_eff may be fixed, scaled, profiled, adaptively selected, signaled, or learned. In one embodiment, recognition coverage evaluation stage 630 computes F_cov(f_s; X_eff) for one or more coefficient positions or transform bands.

Quantization adjustment stage 640 may generate one or more recognition-optimized quantization values based on the output of recognition coverage evaluation stage 630 and the baseline quantization values received at baseline quantization input stage 610. In one embodiment, a recognition-optimized quantization value Q_RO is computed according to Q_RO=Q_base/(1+F_cov(f_s; X_eff)), where Q_base is a baseline quantization value and f_s is a nonnegative metric associated with coefficient position, transform-domain location, or related significance structure. In some embodiments, this operation yields differentiated quantization values across coefficient positions or bands. In some embodiments, such differentiated quantization values may preserve selected higher-significance structures more effectively while still enabling aggressive compression of lower-significance content.

In some embodiments, quantization adjustment stage 640 may apply one or more additional modifiers to the quantization values. For example, a region-priority modifier, quality-tier modifier, rate-control modifier, frame-type modifier, device-capability modifier, or content-class modifier may be applied in conjunction with the recognition-based adjustment. In some embodiments, an effective quantization value Q_eff may be generated according to Q_eff=T_seg*Q_RO, where T_seg is a segmentation-based modifier. In some embodiments, T_seg may be discrete, continuous, region-specific, block-specific, tile-specific, or frame-specific. In some embodiments, T_seg may be selected so that higher-priority regions are quantized less aggressively than lower-priority regions.

In some embodiments, quantization adjustment stage 640 may include clamping logic, minimum-value logic, maximum-value logic, integer rounding, fixed-point conversion, floating-point handling, table lookup, interpolation, reciprocal approximation, hardware-friendly approximation, or combinations thereof. In some embodiments, quantization values may be forced to remain within a selected range. In some embodiments, quantization adjustment stage 640 may produce integer quantization values suitable for use in block-based entropy-coding pipelines. In some embodiments, quantization adjustment stage 640 may produce floating-point or fixed-point intermediate values that are later converted to a desired implementation format.

Optimized quantization output stage 650 may output the resulting recognition-optimized quantization structure for use in quantizing transform coefficients. In one embodiment, optimized quantization output stage 650 outputs recognition-optimized quantization values for use with recognition-scaled coefficients generated according to FIG. 5. In some embodiments, optimized quantization output stage 650 outputs quantization values for use with coefficients that were not recognition-scaled. In some embodiments, optimized quantization output stage 650 may also output side information, profile identifiers, normalization indicators, region-priority identifiers, channel identifiers, transform identifiers, or other associated control data.

In one example operation, baseline quantization input stage 610 receives a baseline quantization matrix for a block-based transform representation. Quantization-metric determination stage 620 determines a nonnegative metric for each coefficient location, such as a metric based on coefficient position. Recognition coverage evaluation stage 630 computes a recognition response for each position according to F_cov(f_s; X_eff). Quantization adjustment stage 640 then modifies the baseline quantization values according to Q_RO=Q_base/(1+F_cov(f_s; X_eff)). The resulting recognition-optimized quantization values are provided by optimized quantization output stage 650 for use during coefficient quantization.

In some embodiments, recognition-optimized quantization generation flow 600 may be applied uniformly across an entire image, frame, or media object. In some embodiments, distinct recognition-optimized quantization structures may be generated for different channels, regions, tiles, block classes, frame types, subbands, or operational profiles. In some embodiments, recognition-optimized quantization generation flow 600 may be performed once and reused across multiple blocks or frames. In some embodiments, recognition-optimized quantization generation flow 600 may be dynamically recomputed in response to scene changes, content changes, rate-control updates, or segmentation updates.

In some embodiments, recognition-optimized quantization generation flow 600 may be used with transform-domain representations other than a standard block DCT. For example, when the transform representation is wavelet-based, distinct quantization values may be generated for different subbands, scales, or orientations. When the transform representation is temporal or residual-based, recognition-optimized quantization values may be generated for temporal-frequency components or residual coefficient classes. When the transform representation is hierarchical or multiscale, recognition-optimized quantization generation flow 600 may operate across levels or across selected levels.

In some embodiments, recognition-optimized quantization generation flow 600 may support different operating modes. In a first mode, a fixed baseline quantization structure and fixed recognition parameter are used. In a second mode, the recognition parameter varies according to a bitrate or quality target. In a third mode, region-priority information modulates the generated quantization values. In a fourth mode, different quantization policies are applied for different content classes, such as medical imagery, geospatial imagery, consumer imagery, or video content. In some embodiments, two or more such modes may be combined.

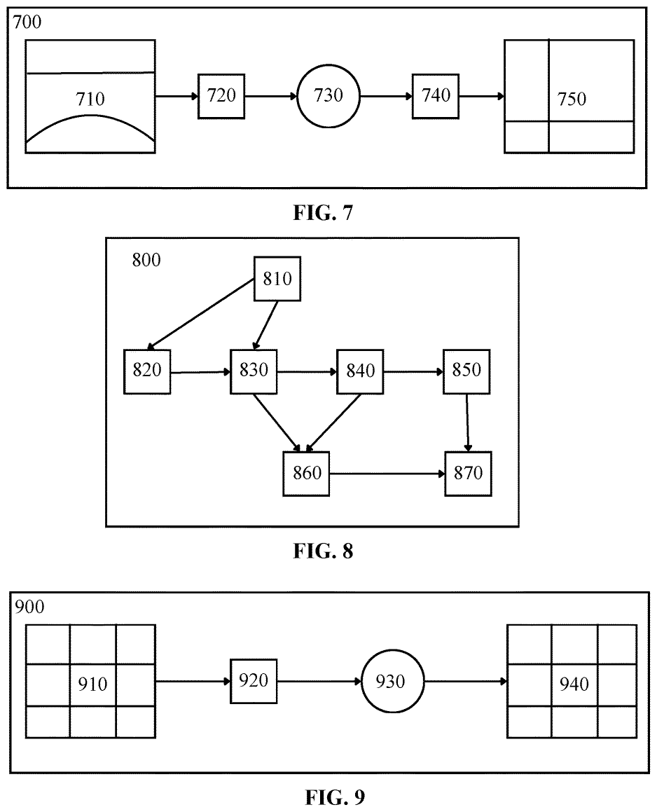

Although FIG. 6 illustrates a particular recognition-optimized quantization workflow using a particular quantization-adjustment relation and a particular recognition coverage function, the disclosed subject matter is not limited to this exact arrangement in all embodiments. Other nonnegative quantization metrics, normalization policies, adjustment relations, transform-location metrics, and implementation strategies may be used while preserving the general principle of recognition-informed quantization optimization. Further details regarding recognition-based adaptive segmentation are described below with reference to FIG. 7.

FIG. 7 illustrates an example recognition-based adaptive segmentation flow 700 in which spatial-domain regions are evaluated using one or more recognition metrics to generate a quality map, priority map, segmentation map, or region-classification output for region-dependent compression control. In the illustrated embodiment, recognition-based adaptive segmentation flow 700 may include a media region input stage 710, a region-metric extraction stage 720, a recognition coverage evaluation stage 730, a region classification and priority determination stage 740, and a segmentation output stage 750. In various embodiments, one or more stages of recognition-based adaptive segmentation flow 700 may be combined, subdivided, reordered, repeated, omitted, or implemented in parallel.

Media region input stage 710 may receive image data, frame data, tile data, block data, slice data, channel data, plane data, or other spatial-domain or spatiotemporal media content for segmentation-related analysis. In some embodiments, media region input stage 710 operates on full-resolution image data. In some embodiments, media region input stage 710 operates on downsampled image data, preview-resolution image data, luminance data, selected channels, edge-enhanced data, or combinations thereof. In some embodiments, media region input stage 710 receives still-image data. In some embodiments, media region input stage 710 receives video frame data or frame-sequence data. In some embodiments, media region input stage 710 may operate on transformed data that has been returned to an intermediate spatial representation or on jointly analyzed spatial-domain and transform-domain information.

Region-metric extraction stage 720 may generate one or more nonnegative recognition metrics associated with spatial regions, blocks, tiles, pixels, windows, frames, or other media subdivisions. In one embodiment, region-metric extraction stage 720 computes a gradient-related metric and a contrast-related metric for a given region. In one implementation, a region recognition metric r_seg may be derived from gradient magnitude and local contrast. In one embodiment, r_seg may be computed according to r_seg=g*c, where g represents a gradient-related measure and c represents a contrast-related measure. In other embodiments, region-metric extraction stage 720 may use local variance, local entropy, edge strength, corner strength, texture energy, saliency, motion magnitude, temporal change, text likelihood, face likelihood, object likelihood, anatomical relevance, geospatial feature relevance, or combinations thereof.

In some embodiments, region-metric extraction stage 720 may apply normalization to one or more region metrics before further processing. In some embodiments, normalization may be performed per image, per frame, per tile, per block class, per region class, or per application profile. In some embodiments, normalization may account for bit depth, dynamic range, channel type, imaging modality, noise characteristics, capture device, content class, or combinations thereof. In some embodiments, region-metric extraction stage 720 may generate a dimensionless recognition metric suitable for use with a recognition coverage function. In some embodiments, region-metric extraction stage 720 may produce multiple metrics that are combined according to a weighted, multiplicative, additive, piecewise, or learned relation.

Recognition coverage evaluation stage 730 may apply a recognition coverage function to the region recognition metric generated by region-metric extraction stage 720. In one embodiment, recognition coverage evaluation stage 730 computes F_cov(r; X)=r/(r+X), where r corresponds to a nonnegative region recognition metric and X is a positive parameter. In one embodiment, X is set equal to phi/pi. In some embodiments, an effective recognition parameter X_eff is used. In some embodiments, X_eff may be fixed, scaled, profiled, adaptively selected, signaled, or learned. In one embodiment, a region recognition response R is generated according to R=F_cov(r_seg; X_eff).

Region classification and priority determination stage 740 may use the output of recognition coverage evaluation stage 730 to assign compression-related treatment to one or more media regions. In some embodiments, region classification and priority determination stage 740 assigns one or more discrete classes, such as higher-priority, intermediate-priority, and lower-priority classes. In some embodiments, region classification and priority determination stage 740 generates a continuous quality value, continuous weighting value, or continuous bitrate-priority value. In some embodiments, the resulting output is used to control quantization strength, transform selection, recognition-scaling strength, thresholding policy, entropy-coding policy, reconstruction policy, bitrate allocation, or combinations thereof.

In one embodiment, region classification and priority determination stage 740 compares the region recognition response R to one or more thresholds to determine a class assignment. For example, a first threshold may distinguish lower-priority regions from intermediate-priority regions, and a second threshold may distinguish intermediate-priority regions from higher-priority regions. In some embodiments, thresholds may be fixed. In some embodiments, thresholds may be adaptively selected according to image content, frame content, bitrate targets, application mode, content class, or device capabilities. In some embodiments, discrete class assignments may be replaced by continuous scaling factors or priority values.

In some embodiments, region classification and priority determination stage 740 may generate a segmentation modifier T_seg for use in other stages of the compression pipeline. In one embodiment, T_seg may be used to modulate quantization values so that higher-priority regions receive less aggressive quantization than lower-priority regions. In some embodiments, T_seg may be used to modulate recognition-scaling strength, transform size selection, coefficient thresholding, entropy-coding contexts, or reconstruction emphasis. In some embodiments, T_seg may be discrete, continuous, block-specific, tile-specific, frame-specific, channel-specific, or application-specific.

Segmentation output stage 750 may output one or more segmentation-related structures for downstream compression processing. In some embodiments, segmentation output stage 750 outputs a priority map, quality map, segmentation mask, region-classification map, weighting map, modifier map, or another structure representing differential compression treatment across media regions. In some embodiments, segmentation output stage 750 outputs region metadata, profile identifiers, region thresholds, normalization parameters, mode flags, or side information for downstream use. In some embodiments, segmentation output stage 750 provides output to a quantization stage, a transform selection stage, a coefficient-scaling stage, an entropy-coding stage, a bitstream generation stage, or combinations thereof.

In one example operation, media region input stage 710 receives image data for a frame or still image. Region-metric extraction stage 720 computes gradient magnitude and local contrast values for a plurality of regions. A region recognition metric r_seg is determined for each region according to a selected relation, such as r_seg=g*c. Recognition coverage evaluation stage 730 computes a region response according to R=F_cov(r_seg; X_eff). Region classification and priority determination stage 740 then assigns each region to a higher-priority, intermediate-priority, or lower-priority class, or otherwise assigns a continuous priority value. Segmentation output stage 750 outputs a corresponding segmentation structure for use in controlling region-dependent compression behavior.

In some embodiments, recognition-based adaptive segmentation flow 700 may operate at different granularities. In some embodiments, segmentation is performed at the pixel level. In some embodiments, segmentation is performed at the block level, tile level, superblock level, object level, slice level, or frame level. In some embodiments, multiple granularities may be combined, such as a coarse region map used together with a finer block-level refinement. In some embodiments, segmentation may be recomputed for each frame, periodically updated, or reused across multiple frames.

In some embodiments, recognition-based adaptive segmentation flow 700 may be particularly useful for preserving structures that are significant for human or machine interpretation. For example, segmentation may identify text-bearing regions, facial regions, diagnostic anatomical regions, geospatial boundary regions, road networks, target objects, interface graphics, line art, or other structures that may benefit from reduced compression aggressiveness. In some embodiments, lower-priority regions such as smooth backgrounds, low-detail areas, low-saliency areas, or recognition-insignificant textures may be compressed more aggressively.

In some embodiments, recognition-based adaptive segmentation flow 700 may be used independently of transform-domain recognition scaling and independently of recognition-optimized quantization. In some embodiments, recognition-based adaptive segmentation flow 700 may be used jointly with one or both of those mechanisms. In some embodiments, segmentation may be performed before transform processing so as to influence block formation or transform selection. In some embodiments, segmentation may be performed after transform generation so as to incorporate transform-domain metrics. In some embodiments, segmentation may be updated iteratively based on intermediate compression results.

In some embodiments, region-metric extraction stage 720 and region classification and priority determination stage 740 may be implemented using classical image-processing operations, heuristic logic, statistical logic, or machine-learning-assisted logic. For example, a machine-learning model may be used to predict saliency, object importance, text presence, anatomical relevance, or quality sensitivity, and such outputs may be combined with gradient or contrast information to form the region recognition metric. In some embodiments, however, machine learning is optional and not required.

Although FIG. 7 illustrates a particular recognition-based adaptive segmentation workflow using a region recognition metric and a recognition coverage function, the disclosed subject matter is not limited to this exact arrangement in all embodiments. Other region metrics, normalization policies, region-classification policies, continuous weighting policies, and implementation strategies may be used while preserving the general principle of recognition-informed differential compression treatment across media regions. Further details regarding joint operation of the disclosed mechanisms are described below with reference to FIG. 8.

FIG. 8 illustrates an example combined compression workflow 800 in which recognition-scaled coefficient processing, recognition-optimized quantization, and recognition-based adaptive segmentation are jointly applied within a unified media compression pipeline. In the illustrated embodiment, combined compression workflow 800 may include a media input and preparation stage 810, a segmentation-guided analysis stage 820, a transform and coefficient generation stage 830, a recognition-scaled coefficient stage 840, a recognition-optimized quantization stage 850, a region-adaptive compression control stage 860, and an encoded output generation stage 870. In various embodiments, one or more stages of combined compression workflow 800 may be combined, subdivided, reordered, repeated, omitted, or implemented in parallel.

Media input and preparation stage 810 may receive source media data and prepare the source media data for coordinated recognition-informed compression. In some embodiments, media input and preparation stage 810 receives a still image. In some embodiments, media input and preparation stage 810 receives video frame data, image-sequence data, multispectral data, medical image data, geospatial image data, text-bearing image data, or other media content. In some embodiments, media input and preparation stage 810 performs one or more preparation operations, including normalization, color-space handling, plane separation, denoising, alignment, padding, cropping, channel selection, or combinations thereof. In some embodiments, media input and preparation stage 810 may also initialize profile data, parameter data, bitrate targets, quality targets, or application-specific control settings.

Segmentation-guided analysis stage 820 may analyze the prepared media data to generate region-dependent control information used by later stages of combined compression workflow 800. In one embodiment, segmentation-guided analysis stage 820 generates a recognition-based segmentation map, quality map, priority map, weighting map, or region-classification output according to the recognition-based adaptive segmentation techniques described above. In some embodiments, segmentation-guided analysis stage 820 also identifies region classes, compression tiers, transform-selection preferences, or quality-preservation policies for different portions of the media data. In some embodiments, segmentation-guided analysis stage 820 operates before transform generation so as to influence partitioning, block formation, transform size selection, or compression-policy assignment.

Transform and coefficient generation stage 830 may generate transform-domain representations for the prepared media data. In one embodiment, transform and coefficient generation stage 830 partitions the media data into blocks and computes transform coefficients for the blocks. In one embodiment, the transform is a discrete cosine transform. In other embodiments, transform and coefficient generation stage 830 may apply a discrete wavelet transform, integer transform, lapped transform, temporal transform, predictive residual transform, hybrid transform, multiscale transform, or other transform-domain process. In some embodiments, transform and coefficient generation stage 830 may use region-priority information generated by segmentation-guided analysis stage 820 to vary block size, transform type, transform strength, transform granularity, transform skip policy, or combinations thereof.

Recognition-scaled coefficient stage 840 may receive coefficients generated by transform and coefficient generation stage 830 and apply recognition-informed coefficient scaling to the coefficients. In one embodiment, recognition-scaled coefficient stage 840 computes a coefficient recognition metric for each coefficient, evaluates a recognition coverage function using the coefficient recognition metric, and generates a recognition-scaled coefficient according to a bounded recognition-based relation. In one implementation, the recognition-scaled coefficient is computed according to C_RS=d*F_cov(abs(d); X_eff). In some embodiments, recognition-scaled coefficient stage 840 may use region-priority information from segmentation-guided analysis stage 820 to vary scaling strength across different regions, channels, frames, coefficient classes, or transform bands.

Recognition-optimized quantization stage 850 may generate or select quantization values for use in quantizing coefficients output by recognition-scaled coefficient stage 840. In one embodiment, recognition-optimized quantization stage 850 generates recognition-optimized quantization values according to Q_RO=Q_base/(1+F_cov(f_s; X_eff)). In some embodiments, recognition-optimized quantization stage 850 further incorporates region-priority modifiers, bitrate-control modifiers, quality-control modifiers, or frame-type modifiers when generating effective quantization values. In some embodiments, recognition-optimized quantization stage 850 may operate on a per-block basis, per-tile basis, per-region basis, per-frame basis, per-channel basis, or according to another selected granularity.

Region-adaptive compression control stage 860 may coordinate outputs from segmentation-guided analysis stage 820, recognition-scaled coefficient stage 840, and recognition-optimized quantization stage 850 to impose differential compression behavior across the media data. In some embodiments, region-adaptive compression control stage 860 assigns stronger compression to lower-priority regions and reduced compression to higher-priority regions. In some embodiments, region-adaptive compression control stage 860 modifies transform selection, coefficient thresholding, quantization strength, symbol ordering, entropy-coding contexts, side-information generation, or combinations thereof according to region class. In some embodiments, region-adaptive compression control stage 860 may impose continuous variation across regions rather than discrete class-based treatment.

Encoded output generation stage 870 may generate a compressed representation based on outputs of the preceding stages. In some embodiments, encoded output generation stage 870 quantizes coefficients using the selected quantization values, prepares symbols, performs entropy coding, and assembles compressed media output. In some embodiments, encoded output generation stage 870 also generates side information, including transform identifiers, block-size identifiers, segmentation identifiers, region-class indicators, recognition-parameter indicators, quality-tier indicators, normalization parameters, compatibility flags, or combinations thereof. In some embodiments, the resulting compressed representation may be stored, transmitted, streamed, packetized, archived, or passed to a downstream reconstruction system.

In one example operation, media input and preparation stage 810 receives image data and prepares the image data for compression. Segmentation-guided analysis stage 820 generates a region-priority structure indicating areas of comparatively higher and lower significance. Transform and coefficient generation stage 830 generates coefficients for a plurality of image blocks. Recognition-scaled coefficient stage 840 applies recognition-informed scaling to the coefficients. Recognition-optimized quantization stage 850 generates quantization values using a recognition-informed adjustment. Region-adaptive compression control stage 860 applies segmentation-informed differential compression policies across the image. Encoded output generation stage 870 then generates the compressed output bitstream.

In some embodiments, the combined compression workflow 800 may provide coordinated control across multiple compression stages, thereby improving consistency relative to systems in which coefficient scaling, quantization adaptation, and region-based prioritization are implemented independently or without a shared recognition framework. In some embodiments, the use of a common recognition coverage function across multiple stages may allow coefficient-domain, frequency-domain, and spatial-domain behaviors to be tuned in a harmonized manner. In some embodiments, such coordinated tuning may improve rate-distortion performance, improve structural preservation, improve recognition-sensitive quality retention, or improve content-specific compression behavior.

In some embodiments, one or more of the stages shown in combined compression workflow 800 may be omitted. For example, some embodiments may use recognition-scaled coefficient processing and recognition-optimized quantization without segmentation-guided analysis. Some embodiments may use segmentation-guided analysis and recognition-optimized quantization without coefficient scaling. Some embodiments may use segmentation-guided analysis and coefficient scaling without quantization optimization. In some embodiments, region-adaptive compression control stage 860 may be integrated directly into recognition-scaled coefficient stage 840 or recognition-optimized quantization stage 850.

In some embodiments, combined compression workflow 800 may operate iteratively. For example, an initial segmentation-guided analysis may be used to guide a first-pass compression, after which one or more parameters may be adjusted based on provisional bitrate, provisional quality, provisional distortion, provisional region fidelity, or combinations thereof. In some embodiments, combined compression workflow 800 may perform one-pass processing. In some embodiments, combined compression workflow 800 may perform multi-pass processing. In some embodiments, combined compression workflow 800 may be configured for real-time encoding, low-latency encoding, archival encoding, cloud transcoding, or application-specific workflows.

In some embodiments, combined compression workflow 800 may be implemented using software executed on one or more processors, using specialized hardware, or using distributed computing resources. In some embodiments, segmentation-guided analysis stage 820 may be implemented on a first processor or hardware accelerator, transform and coefficient generation stage 830 and recognition-scaled coefficient stage 840 may be implemented on a graphics processing unit or digital signal processor, and encoded output generation stage 870 may be implemented on another processor or hardware accelerator. In some embodiments, different stages may be distributed across edge devices, servers, cloud systems, or hybrid client-server architectures.

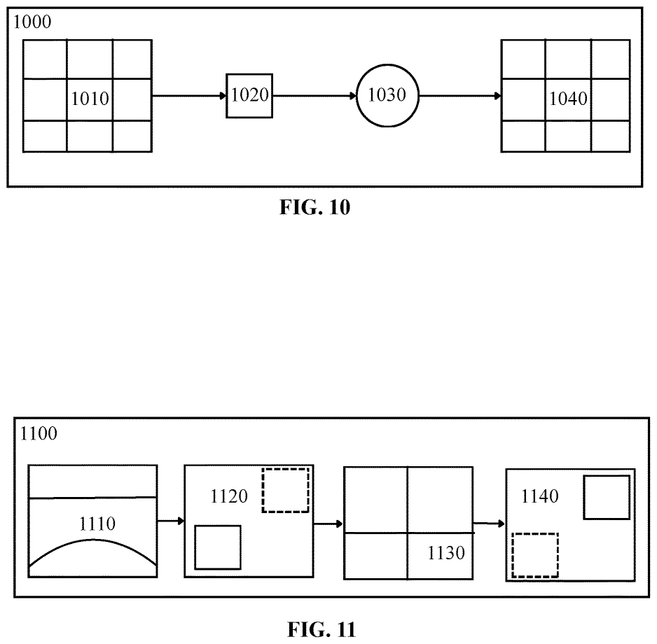

Although FIG. 8 illustrates a particular coordinated arrangement of stages, the disclosed subject matter is not limited to the illustrated embodiment. The stages may be reordered, modified, repeated, combined, or partially bypassed depending on implementation preferences, hardware architecture, media type, bitrate target, quality target, latency requirements, compatibility requirements, or application-specific constraints. Additional example representations of coefficient behavior and quantization behavior are described below with reference to FIGS. 9 and 10.

FIG. 9 illustrates an example transform-coefficient representation 900 showing representative coefficient values before and after recognition-based scaling for a block or transform-domain media portion. In the illustrated embodiment, transform-coefficient representation 900 may include an original coefficient set 910, a coefficient significance evaluation stage 920, a recognition-scaling stage 930, and a resulting scaled coefficient set 940. In various embodiments, FIG. 9 may be implemented as a tabular representation, matrix representation, coefficient-grid representation, heat-map representation, ordered coefficient list, or another visual arrangement suitable for illustrating coefficient behavior before and after recognition-based scaling.

Original coefficient set 910 may represent transform coefficients generated from a selected media portion, such as an image block, tile, frame region, subband region, or other transformed media structure. In one embodiment, original coefficient set 910 corresponds to an 8 by 8 transform block produced from image data. In other embodiments, original coefficient set 910 may correspond to coefficients produced from a different block size, transform arrangement, subband structure, or multiscale representation. In some embodiments, original coefficient set 910 includes a direct-current coefficient and a plurality of alternating-current coefficients. In some embodiments, original coefficient set 910 may include signed coefficient values of varying magnitude distributed across lower-frequency and higher-frequency positions.

Coefficient significance evaluation stage 920 may determine one or more recognition metrics corresponding to the coefficients in original coefficient set 910. In one embodiment, the recognition metric for a given coefficient is based on the absolute value of that coefficient. In some embodiments, coefficient significance evaluation stage 920 computes a nonnegative significance value for each coefficient according to r_coeff =abs(d), where d is the coefficient value. In other embodiments, coefficient significance evaluation stage 920 may compute normalized magnitude, normalized energy, local coefficient-context significance, neighborhood significance, band-based significance, or another nonnegative coefficient-related metric. In some embodiments, the computed significance values are dimensionless or normalized prior to use in recognition scaling.

Recognition-scaling stage 930 may apply a recognition coverage function to the significance values determined at coefficient significance evaluation stage 920 in order to generate scaled coefficient values. In one embodiment, recognition-scaling stage 930 computes F_cov(r; X) =r / (r +X), where r is a nonnegative coefficient significance value and X is a positive parameter. In one embodiment, X is set equal to phi/pi. In some embodiments, an effective parameter X_eff is used. In one embodiment, each original coefficient d is converted to a scaled coefficient C_RS according to C_RS =d * F_cov(abs(d); X_eff). In such an embodiment, coefficients having comparatively low magnitude may be attenuated more strongly than coefficients having comparatively high magnitude.

Resulting scaled coefficient set 940 may represent the coefficients after application of the recognition-scaling relation. In one embodiment, lower-magnitude coefficients in resulting scaled coefficient set 940 have magnitudes reduced relative to their corresponding values in original coefficient set 910, while larger coefficients remain more strongly preserved. In some embodiments, the sign of each coefficient is preserved. In some embodiments, the resulting scaled coefficient set 940 exhibits increased sparsity, increased effective compressibility, or improved alignment with downstream quantization and entropy-coding objectives. In some embodiments, scaled coefficient values may be represented as real-valued intermediate quantities prior to quantization. In some embodiments, scaled coefficient values may be rounded, clipped, or otherwise conditioned before further processing.

In one example implementation, FIG. 9 may illustrate a representative coefficient matrix in which certain lower-magnitude higher-frequency coefficients become smaller in magnitude after recognition scaling, while larger low-frequency or structure-bearing coefficients remain comparatively less attenuated. In some embodiments, this illustrative behavior may help demonstrate how recognition scaling may reduce the contribution of lower-significance coefficients without relying solely on hard thresholding. In some embodiments, a figure corresponding to FIG. 9 may depict actual numeric values, symbolic values, relative shading, or other visual indicators of coefficient magnitude before and after scaling.

In some embodiments, the transform-coefficient representation 900 may be used to illustrate different operating modes. For example, a first representation may show coefficient behavior using a first value of X_eff, and a second representation may show coefficient behavior using a second value of X_eff. In some embodiments, the figure may illustrate different results for different media classes, different channels, different block types, different transform types, or different quality modes. In some embodiments, the figure may illustrate that the strength of coefficient attenuation varies continuously with coefficient significance rather than abruptly according to a hard cutoff.

In some embodiments, FIG. 9 may also illustrate selective coefficient treatment. For example, one representation may show direct-current coefficients being passed through unchanged while alternating-current coefficients are recognition-scaled. Another representation may show all coefficients being recognition-scaled. In some embodiments, a figure corresponding to FIG. 9 may show that different classes of coefficients, such as luma coefficients and chroma coefficients, may be recognition-scaled according to different parameter values, different normalization rules, or different significance definitions.

In some embodiments, transform-coefficient representation 900 may be used in connection with wavelet coefficients, multiscale coefficients, residual coefficients, temporal coefficients, or other non-DCT transform-domain representations. In such embodiments, original coefficient set 910 and resulting scaled coefficient set 940 may correspond to subband coefficients, temporal-frequency coefficients, predictive residual coefficients, or hierarchical coefficient structures. In some embodiments, the general principle remains that recognition-informed scaling modifies coefficient magnitudes according to one or more nonnegative significance measures prior to quantization or related compression treatment.

In some embodiments, the example shown in FIG. 9 may be illustrative rather than limiting. The number of coefficients shown, their arrangement, their values, and the degree of attenuation may vary according to content, transform type, block size, parameter values, normalization choices, and implementation details. In some embodiments, the values shown in the figure may be representative. In some embodiments, the values shown in the figure may be simplified for ease of explanation.

The transform-coefficient representation described with respect to FIG. 9 provides an example of how recognition-informed scaling may alter coefficient distributions prior to quantization and coding. Additional example behavior associated with recognition-optimized quantization is described below with reference to FIG. 10.

FIG. 10 illustrates an example quantization structure 1000 showing representative baseline quantization values and recognition-optimized quantization values for a transform-domain arrangement. In the illustrated embodiment, quantization structure 1000 may include a baseline quantization structure 1010, a quantization-metric evaluation stage 1020, a recognition-based quantization adjustment stage 1030, and a resulting optimized quantization structure 1040. In various embodiments, FIG. 10 may be implemented as a quantization matrix representation, a table representation, a coefficient-position representation, a band-based representation, a heat-map representation, or another arrangement suitable for illustrating quantization behavior before and after recognition-based adjustment.

Baseline quantization structure 1010 may represent one or more initial quantization values used as a starting point for transform-domain quantization. In one embodiment, baseline quantization structure 1010 corresponds to a matrix of quantization values associated with coefficient positions in a block-based transform representation. In some embodiments, baseline quantization structure 1010 may be based on a standard or conventional quantization matrix. In some embodiments, baseline quantization structure 1010 may be generated according to a selected codec profile, application mode, quality target, bitrate target, or content class. In some embodiments, baseline quantization structure 1010 may be fixed. In some embodiments, baseline quantization structure 1010 may be adaptively generated or selected.

Quantization-metric evaluation stage 1020 may determine one or more nonnegative metrics associated with positions, bands, or classes of transform coefficients represented in baseline quantization structure 1010. In one embodiment, a position-related metric f_s is determined for each coefficient position according to the position of that coefficient within the transform-domain arrangement. In one embodiment, the metric may be based on u+v, where u and v correspond to coefficient-position coordinates. In other embodiments, the metric may be based on radial distance, zig-zag order, band index, weighted position, temporal-frequency class, subband orientation, or another transform-location-related significance indicator. In some embodiments, the metric values may be normalized or otherwise conditioned before further processing.

Recognition-based quantization adjustment stage 1030 may apply a recognition coverage function to the quantization metric values generated at quantization-metric evaluation stage 1020 and may use the resulting response values to modify the baseline quantization structure 1010. In one embodiment, recognition-based quantization adjustment stage 1030 computes F_cov(r; X)=r/(r+X), where r corresponds to a selected nonnegative quantization metric and X is a positive parameter. In one embodiment, X is set equal to phi/pi. In some embodiments, an effective parameter X_eff is used. In one embodiment, a recognition-optimized quantization value Q_RO is computed according to Q_RO=Q_base/(1+F_cov(f_s; X_eff)), where Q_base is a baseline quantization value for a selected coefficient position.

Resulting optimized quantization structure 1040 may represent the quantization values after application of the recognition-based adjustment relation. In some embodiments, resulting optimized quantization structure 1040 includes quantization values that differ across coefficient positions in a manner influenced by the selected recognition metric and recognition coverage function. In some embodiments, one or more quantization values in resulting optimized quantization structure 1040 may be reduced relative to corresponding baseline values so that selected coefficient positions are quantized less aggressively. In some embodiments, the degree of quantization adjustment may vary smoothly across coefficient positions, transform bands, or other structural groupings.

In one example implementation, FIG. 10 may illustrate a baseline quantization matrix and a corresponding recognition-optimized quantization matrix for an 8 by 8 transform block. In some embodiments, the figure may show that quantization values associated with selected coefficient positions are modified according to the relation described above so that the resulting optimized quantization structure 1040 reflects recognition-informed differentiation rather than a purely static baseline table. In some embodiments, the figure may depict actual representative numeric values. In some embodiments, the figure may depict relative differences or color-coded differences between baseline and optimized values.

In some embodiments, the quantization adjustment illustrated in FIG. 10 may further reflect region-dependent or application-dependent control. For example, a first optimized quantization structure 1040 may be used for higher-priority regions and a second optimized quantization structure 1040 may be used for lower-priority regions. In some embodiments, the figure may illustrate different optimized quantization structures for luma channels and chroma channels. In some embodiments, the figure may illustrate different optimized quantization structures corresponding to different bitrate modes, quality modes, or profile selections.

In some embodiments, recognition-based quantization adjustment stage 1030 may include additional operations not explicitly shown in simplified figure form. For example, quantization values may be clamped to a selected minimum or maximum range, rounded to integer values, converted to fixed-point values, selected from a table, generated from a learned model, or modified according to region-priority modifiers or frame-type modifiers. In some embodiments, an effective quantization value may be computed according to Q_eff=T_seg*Q_RO, where T_seg is a segmentation-related modifier. In some embodiments, FIG. 10 may be used to illustrate such region-adaptive quantization behavior.

In some embodiments, the quantization structure 1000 shown in FIG. 10 may correspond to transform representations other than a standard block DCT. For example, in a wavelet-based embodiment, baseline quantization structure 1010 and resulting optimized quantization structure 1040 may correspond to subband-specific quantization values, scale-specific quantization values, or orientation-specific quantization values. In a temporal or residual embodiment, the figure may correspond to temporal-frequency quantization values, residual-class quantization values, or predictive residual quantization parameters. In a multiscale embodiment, the figure may illustrate quantization values across multiple levels.

In some embodiments, the example shown in FIG. 10 may be illustrative rather than limiting. The values depicted, the number of entries shown, the arrangement of entries, the metric used, and the degree of adjustment may vary according to transform type, content type, bitrate target, quality target, normalization strategy, region-priority strategy, and implementation details. In some embodiments, the figure may be simplified for explanatory clarity. In some embodiments, the figure may show representative values derived from a sample implementation.

The quantization structure described with respect to FIG. 10 provides an example of how recognition-informed processing may alter quantization behavior prior to coding and reconstruction. Additional example behavior associated with region-based prioritization is described below with reference to FIG. 11.

FIG. 11 illustrates an example region-based prioritization result 1100 showing differential compression treatment across media portions identified as higher-priority, intermediate-priority, and lower-priority regions. In the illustrated embodiment, region-based prioritization result 1100 may include an input media representation 1110, a region-analysis result 1120, a priority assignment representation 1130, and a compression-treatment result 1140. In various embodiments, FIG. 11 may be implemented as an image overlay, segmentation mask, tier map, quality map, weighting map, block map, tile map, or another spatial representation suitable for illustrating region-dependent compression behavior.

Input media representation 1110 may correspond to a source image, image region, video frame, grayscale image, color image, multispectral image, medical image, geospatial image, text-bearing image, or other media content subjected to recognition-based adaptive segmentation. In some embodiments, input media representation 1110 may be shown in full resolution. In some embodiments, input media representation 1110 may be shown in reduced resolution or in a simplified illustrative form. In some embodiments, input media representation 1110 may include multiple classes of visual structure, such as edges, smooth backgrounds, textures, text regions, object regions, facial regions, anatomical regions, or geospatial features.

Region-analysis result 1120 may represent outputs of a recognition-based segmentation analysis applied to input media representation 1110. In one embodiment, region-analysis result 1120 reflects one or more region metrics derived from gradient magnitude, local contrast, structural strength, texture energy, saliency, motion, text likelihood, object likelihood, anatomical relevance, geospatial feature relevance, or combinations thereof. In some embodiments, region-analysis result 1120 may be expressed as a spatial heat map, a block-level score map, a region-weighting representation, or another visual or symbolic indication of relative regional significance.

Priority assignment representation 1130 may indicate the assignment of regions to one or more priority classes or priority values based on the region-analysis result 1120. In one embodiment, priority assignment representation 1130 assigns regions to a higher-priority class, an intermediate-priority class, or a lower-priority class. In some embodiments, such classes may correspond to distinct compression tiers. In some embodiments, priority assignment representation 1130 may instead represent a continuous priority value or a continuous weighting field. In some embodiments, the figure may use distinct shading, patterns, labels, color regions, numeric values, or boundary outlines to distinguish the assigned priorities.

Compression-treatment result 1140 may represent the differing compression behavior applied across regions in response to the priority assignments indicated in priority assignment representation 1130. In one embodiment, higher-priority regions may receive less aggressive compression, less aggressive quantization, weaker coefficient attenuation, greater bitrate allocation, or combinations thereof. In one embodiment, lower-priority regions may receive more aggressive compression, more aggressive quantization, stronger coefficient attenuation, lower bitrate allocation, or combinations thereof. In some embodiments, intermediate-priority regions may receive treatment between those of the higher-priority and lower-priority classes.

In one example implementation, FIG. 11 may illustrate a source image containing a visually or functionally significant subject region together with a less significant background region. In such an implementation, the region-analysis result 1120 may indicate stronger significance values for edges, boundaries, text areas, facial features, anatomical structures, roads, geospatial boundaries, or other recognition-relevant content. Priority assignment representation 1130 may then classify those regions as higher priority, while smoother or less informative regions are classified as intermediate or lower priority. Compression-treatment result 1140 may correspondingly indicate differentiated compression policy across those regions.

In some embodiments, the region-based prioritization result 1100 may be based on discrete thresholding. For example, a first threshold may distinguish lower-priority regions from intermediate-priority regions, and a second threshold may distinguish intermediate-priority regions from higher-priority regions. In some embodiments, thresholds may be fixed. In some embodiments, thresholds may be adaptively selected based on image statistics, frame statistics, bitrate targets, quality targets, device capabilities, content classes, or application mode. In some embodiments, discrete classes may be replaced by continuous weighting values used to modulate compression strength across the image.

In some embodiments, the region-based prioritization result 1100 may be used to influence multiple compression stages simultaneously. For example, the priority assignment may affect coefficient scaling strength, quantization values, transform selection, block size, thresholding behavior, entropy-coding contexts, signaling decisions, reconstruction emphasis, or combinations thereof. In some embodiments, the same priority assignment may be used to derive a segmentation modifier T_seg for use in quantization adjustment. In some embodiments, the same priority assignment may determine whether selected regions are treated according to a lossless, near-lossless, or lossy policy.

In some embodiments, FIG. 11 may illustrate block-level prioritization, tile-level prioritization, region-level prioritization, or pixel-level prioritization. In some embodiments, the figure may show coarse regions for ease of explanation even though a finer-grained map is used in practice. In some embodiments, the figure may illustrate temporal prioritization for video by showing how corresponding regions in multiple frames receive consistent or adaptively changing priority assignments. In some embodiments, the figure may show separate prioritization results for different channels or planes.

In some embodiments, the region-based prioritization result 1100 may be particularly useful for preserving content significant to downstream human or machine use. By way of example, text-bearing regions, diagnostic anatomical features, geospatial features, navigational boundaries, line art, interface elements, target objects, or facial regions may be assigned higher priority so that reconstructed output preserves such content more effectively. In some embodiments, less significant backgrounds, low-detail regions, low-saliency regions, or recognition-insignificant textures may be assigned lower priority to permit stronger compression.

In some embodiments, FIG. 11 may be illustrative rather than limiting. The particular image shown, the number of priority classes shown, the boundaries between regions, the metrics used to generate the priorities, and the exact compression consequences of each priority class may vary according to content, implementation, application domain, transform type, bitrate target, quality target, and system design. In some embodiments, the figure may be simplified for explanatory clarity while still conveying the principle of recognition-informed differential compression treatment.

Although FIG. 11 illustrates a representative region-based prioritization result using higher-priority, intermediate-priority, and lower-priority regions, the disclosed subject matter is not limited to three classes. In some embodiments, two classes may be used. In some embodiments, more than three classes may be used. In some embodiments, a fully continuous map may be used in place of discrete classes. In some embodiments, class boundaries may be hard, soft, overlapping, probabilistic, or adaptively updated.

The region-based prioritization result described with respect to FIG. 11 illustrates how recognition-informed segmentation may guide differential compression treatment across media content. In some embodiments, the features described with respect to FIGS. 1 through 11 may be used individually or in combination. In some embodiments, the disclosed subject matter may be implemented in still-image compression systems, video compression systems, distributed transcoding systems, cloud media processing systems, mobile-device capture systems, medical imaging systems, geospatial imaging systems, archival systems, or other machine-implemented media-processing environments.

The foregoing description of the drawings and associated embodiments is illustrative and not limiting. Elements, operations, modules, stages, relations, metrics, parameters, equations, and data structures described in connection with one embodiment may be used in other embodiments. Steps and stages may be performed in different orders unless otherwise required. One or more elements may be omitted, combined, subdivided, repeated, or replaced. The disclosed subject matter encompasses methods, systems, apparatuses, devices, and non-transitory computer-readable media implementing one or more of the features described herein.

In some embodiments, the disclosed media compression operations are performed as a defined sequence of machine-executed algorithmic operations on digital pixel data, transform coefficients, quantization data, region-priority data, and encoded symbol data stored in one or more computer memories. By way of example, one or more processors may execute instructions to receive digital media samples, compute normalization values, generate block or tile partitions, compute transform coefficients, determine coefficient recognition metrics, evaluate one or more recognition coverage functions, generate recognition-scaled coefficients, determine recognition-optimized quantization values, quantize coefficient values, prepare coefficient symbols, entropy code the coefficient symbols, assemble compressed bitstream data, parse compressed bitstream data, inverse quantize coefficient values, perform inverse recognition-aware coefficient reconstruction, perform inverse transform reconstruction, and output reconstructed media data. In some embodiments, these operations are performed using floating-point arithmetic. In some embodiments, these operations are performed using fixed-point arithmetic. In some embodiments, one or more arithmetic operations are implemented using lookup tables, reciprocal approximations, polynomial approximations, vectorized instructions, pipelined hardware logic, or combinations thereof.

In some embodiments, one or more normalization values, scaling values, threshold values, segmentation modifiers, effective recognition parameters, transform identifiers, block-size identifiers, channel identifiers, quantization identifiers, quality-mode identifiers, or compatibility identifiers are computed at an encoder and either signaled in compressed media data or reproducibly derived at a decoder from signaled data, profile data, or deterministic reconstruction rules. In some embodiments, normalization values for coefficient recognition metrics and region recognition metrics are determined per image, per frame, per tile, per block class, per transform band, per channel, or per profile. In some embodiments, the same effective recognition parameter is used for coefficient scaling, quantization adjustment, and segmentation evaluation. In other embodiments, different effective recognition parameters are used for different compression stages, channels, regions, transform types, or frame types. In some embodiments, parameter signaling is explicit. In some embodiments, parameter signaling is implicit through a profile identifier or mode identifier. In some embodiments, parameter signaling is omitted when the corresponding parameter is predetermined.

In some embodiments, compressed media data include a payload portion and a control-information portion. The payload portion may include entropy-coded coefficient data, significance data, run-length data, or related encoded symbol data. The control-information portion may include one or more of a transform type field, block-size field, profile field, recognition-parameter field, normalization field, segmentation field, quality-mode field, channel-mode field, compatibility field, frame-type field, or lossless-versus-lossy mode field. In some embodiments, the control-information portion is stored in a file header, frame header, tile header, block header, side-information section, metadata structure, container structure, or combinations thereof. In some embodiments, control information is signaled once for an image or frame. In some embodiments, control information is signaled separately for multiple regions, channels, tiles, or transform classes.

In some embodiments, the disclosed techniques are implemented in a codec-specific format. In some embodiments, the disclosed techniques are implemented as an extension layer, wrapper layer, metadata-assisted layer, profile layer, or preprocessing layer used with an existing codec framework. By way of example, recognition-scaled coefficient processing, recognition-optimized quantization, recognition-based segmentation, or combinations thereof may be integrated into a JPEG-based workflow, a wavelet-based workflow, a predictive residual workflow, a video coding workflow, or another compression framework. In some embodiments, a recognition-aware decoder uses signaled recognition-related data to perform inverse recognition-aware reconstruction. In some embodiments, a compatibility decoder reconstructs media data without full inverse recognition-aware reconstruction and thereby provides a reduced-complexity or reduced-fidelity decode mode.

In some embodiments, the disclosed subject matter is implemented by one or more computing systems including at least one processor and at least one memory storing instructions that, when executed by the at least one processor, cause the computing system to perform one or more of the operations described herein. In some embodiments, the computing system further includes a graphics processing unit, digital signal processor, field-programmable gate array, application-specific integrated circuit, network interface, storage interface, image sensor interface, display interface, or combinations thereof. In some embodiments, the computing system is a server, workstation, mobile device, embedded device, camera device, medical imaging workstation, satellite imaging system, browser-based system, cloud system, edge system, or hybrid distributed computing system.

What is claimed is:

1. A computer-implemented method for compressing digital media data, the method comprising:
receiving, by one or more processors, input digital media data representing at least one image;
partitioning the input digital media data into a plurality of media portions;
generating, for at least one media portion of the plurality of media portions, a plurality of transform coefficients;
determining, for at least a subset of the plurality of transform coefficients, respective nonnegative coefficient recognition metrics;
applying, to the respective nonnegative coefficient recognition metrics, a bounded recognition coverage function to generate respective recognition response values;
generating recognition-scaled transform coefficients by scaling the at least a subset of the plurality of transform coefficients according to the respective recognition response values;
obtaining a baseline quantization structure;
determining quantization values for the recognition-scaled transform coefficients based on the baseline quantization structure and a frequency-related metric associated with coefficient position;
quantizing the recognition-scaled transform coefficients using the quantization values;
entropy coding the quantized transform coefficients to generate compressed coefficient data; and
generating compressed media data including the compressed coefficient data and signaling data usable to reconstruct the transform coefficients.

2. The method of claim 1, wherein the bounded recognition coverage function is defined as F_cov(r; X)=r/(r+X), where r is the nonnegative coefficient recognition metric and X is a positive parameter.

3. The method of claim 2, wherein X is set to phi/pi.

4. The method of claim 1, wherein the respective nonnegative coefficient recognition metric for a transform coefficient is based on an absolute value of the transform coefficient.

5. The method of claim 1, wherein generating the plurality of recognition-scaled transform coefficients comprises preserving a sign of each transform coefficient while modifying a magnitude of the transform coefficient according to the respective recognition response value.

6. The method of claim 1, wherein determining the plurality of quantization values comprises modifying the baseline quantization structure according to a second application of the bounded recognition coverage function to the frequency-related metric associated with coefficient position.

7. The method of claim 6, wherein the plurality of quantization values are determined according to Q_RO=Q_base/(1+F_cov(f_s; X_eff)), where Q_base is a baseline quantization value, f_s is the frequency-related metric, and X_eff is an effective recognition parameter.

8. The method of claim 1, further comprising:
determining, for a plurality of spatial regions of the input digital media data, respective nonnegative region recognition metrics;
applying the bounded recognition coverage function to the respective nonnegative region recognition metrics to generate a region-priority output; and
modifying at least one of the plurality of quantization values, a transform selection, or a coefficient scaling strength based on the region-priority output.

9. The method of claim 8, wherein each respective nonnegative region recognition metric is based on at least one of gradient magnitude, local contrast, local variance, saliency, motion, text likelihood, object likelihood, anatomical relevance, or geospatial feature relevance.

10. The method of claim 1, wherein generating the plurality of transform coefficients comprises applying at least one transform selected from the group consisting of a discrete cosine transform, a discrete wavelet transform, an integer transform, a lapped transform, a temporal transform, a predictive residual transform, and a hybrid transform.

11. The method of claim 1, wherein the signaling data specifies at least one of a transform type, a block size, an effective recognition parameter, a normalization parameter, a segmentation mode, a quality mode, or a compatibility mode.

12. The method of claim 1, further comprising:
evaluating compression performance using at least one verification metric selected from bitrate in bits per pixel (bpp), peak signal-to-noise ratio (PSNR), structural similarity (SSIM), a perceptual metric, or a task metric for downstream recognition;
applying an acceptance rule that accepts the compressed media data when bpp≤B_target and SSIM≥S_min or PSNR≥P_min; and
when the acceptance rule is not satisfied, adjusting at least one of an effective recognition parameter X_eff, a quantization scaling factor, or a region modifier and repeating at least the quantizing and entropy coding for at least a portion of the input digital media data.

13. The method of claim 1, further comprising decoding the compressed media data by:
entropy decoding the quantized transform coefficients;
inverse quantizing the quantized transform coefficients to generate dequantized recognition-scaled coefficients;
performing inverse recognition-aware coefficient reconstruction on the dequantized recognition-scaled coefficients; and
applying an inverse transform to generate reconstructed media data.

14. The method of claim 13, wherein performing the inverse recognition-aware coefficient reconstruction comprises determining a reconstructed coefficient magnitude according to abs(d)=(abs(C_RS)+sqrt((abs(C_RS)*abs(C_RS))+(4X_eff*abs(C_RS))))/2, where C_RS is a dequantized recognition-scaled coefficient and X_eff is an effective recognition parameter.

15. A system for compressing digital media data, the system comprising:
one or more processors; and
memory storing instructions that, when executed by the one or more processors, cause the system to:
receive input digital media data representing at least one image;
partition the input digital media data into a plurality of media portions;
generate transform coefficients for at least one media portion;
determine respective nonnegative coefficient recognition metrics for at least a subset of the transform coefficients;
apply a bounded recognition coverage function to the respective nonnegative coefficient recognition metrics to generate respective recognition response values;
generate recognition-scaled transform coefficients based on the respective recognition response values;
obtain a baseline quantization structure;
determine quantization values based on the baseline quantization structure and a frequency-related metric associated with coefficient position;
quantize the recognition-scaled transform coefficients using the quantization values;
entropy code the quantized transform coefficients to generate compressed coefficient data; and
generate compressed media data including the compressed coefficient data and signaling data usable for decode-side reconstruction.

16. The system of claim 15, wherein the instructions further cause the system to generate a region-priority output from nonnegative region recognition metrics for a plurality of spatial regions and to modify at least one of the quantization values, transform processing, or coefficient scaling based on the region-priority output.

17. The system of claim 15, wherein the bounded recognition coverage function is defined as F_cov(r; X)=r/(r+X), and wherein the nonnegative coefficient recognition metrics are based on coefficient magnitude.

18. A non-transitory computer-readable medium storing instructions that, when executed by one or more processors, cause the one or more processors to:
receive input digital media data representing at least one image;
partition the input digital media data into a plurality of media portions;
generate transform coefficients for at least one media portion;
determine respective nonnegative coefficient recognition metrics for at least a subset of the transform coefficients;
apply a bounded recognition coverage function to the respective nonnegative coefficient recognition metrics to generate respective recognition response values;
generate recognition-scaled transform coefficients based on the respective recognition response values;
obtain a baseline quantization structure;
determine quantization values based on the baseline quantization structure and a frequency-related metric associated with coefficient position;
quantize the recognition-scaled transform coefficients using the quantization values;
entropy code the quantized transform coefficients to generate compressed coefficient data; and
generate compressed media data including the compressed coefficient data and signaling data usable for decode-side reconstruction.

19. The non-transitory computer-readable medium of claim 18, wherein the instructions further cause the one or more processors to generate a region-priority output from nonnegative region recognition metrics for a plurality of spatial regions and to modify at least one of the quantization values, transform selection, or coefficient scaling strength based on the region-priority output.

20. The non-transitory computer-readable medium of claim 18, wherein the instructions further cause the one or more processors to decode the compressed media data by entropy decoding quantized transform coefficients, inverse quantizing the quantized transform coefficients, performing inverse recognition-aware coefficient reconstruction, and applying an inverse transform to generate reconstructed media data.
